(19) United States
(12) Patent Application Publication
(10) Pub. No.: US 2016/0174777 A1
(43) Pub. Date: Jun. 23, 2016

(54) Scrubby Fibrous Structures and Methods for Making Same

(71) Applicant: The Procter & Gamble Company, Cinicinnati, OH (US)

(72) Inventors: Fei Wang, Mason, OH (US); Cunming Song, Symmes Township, OH (US); Steven Lee Barnholtz, West Chester, OH (US); Michael Donald Suer, Colerain Township, OH (US); Christopher Michael Young, Loveland, OH (US); Timothy Duane Smith, Lebanon, OH (US); Shannon Elizabeth Welsh, Fairfield Township, OH (US)

(73) Assignee: The Procter & Gamble Company

(21) Appl. No.: 14/970,581

(22) Filed: Dec. 16, 2015

Related U.S. Application Data
(60) Provisional application No. 62/094,416, filed on Dec. 19, 2014.

(51) Int. Cl. A47K 10/16; B32B 5/02; B32B 5/26

(52) U.S. Cl. CPC A47K 10/16; B32B 5/26; B32B 5/028; B32B 5/022; B32B 2250/03; B32B 2250/20; B32B 2262/0253; B32B 2307/718; B32B 2555/00

(57) ABSTRACT

Scrubby fibrous structures and more particularly scrubby coform fibrous structures and methods for making same are provided.

### FIELD OF THE INVENTION

The present invention relates to scrubby fibrous structures and more particularly to scrubby coform fibrous structures and methods for making same.

### BACKGROUND OF THE INVENTION

Scrubby fibrous structures are known in the art. For example, as shown in Prior Art FIG. 1, a known multi-layer laminate scrubby fibrous structure 10 consisting of: 1) an abrasive layer 12 (for the present application considered to be a scrubby component) having thermoplastic polymer fibers that exhibit an average diameter of greater than about 30 μm, more typically between 40 μm and 800 μm because the coarser (larger diameter) the fibers, the more helpful the fibers are for providing the abrasive characteristics of the known multi-layer laminate scrubby fibrous structure 10; and 2) an absorbent fibrous layer 14 (for the present application considered to be a core component) is known. This known multi-layer laminate scrubby fibrous structure 10 fails to teach the use of one or more scrim components, for example one or more scrim layers, to help retain any pulp fibers present within the known multi-layer laminate fibrous structure 10.

Another known scrubby fibrous structure comprises a cleaning substrate and a scrubby substrate. This known scrubby fibrous structure, like above, fails to teach the use of one or more scrim components, for example scrim layers, to help retain any pulp fibers present within the known scrubby fibrous structure.

Other known scrubby fibrous structures as shown in Prior Art FIGS. 2A and 2B consist of a known dual textured coform fibrous structure 16 (a scrubby fibrous structure) having one surface 18 that contains coarse filaments (greater than 15 μm diameter filaments) and pulp fibers (for the present application considered to be a core component comprising a scrubby component), which impart an abrasive characteristic to this surface and the other surface 20 contains fine filaments (less than 15 μm diameter filaments) and pulp fibers (for the present application considered to be a core component), which impart a non-abrasive or soft surface to the known dual textured coform fibrous structure 16. Such a known dual textured coform fibrous structure 16 may be a monolayer coform (filaments and pulp fibers) fibrous structure as shown in FIG. 2A or a dual coform (filaments and pulp fibers) layered (first layer with coarse filaments and second layer with fine filaments) fibrous structure as shown in FIG. 2B. Not only does this known dual textured coform fibrous structure 16 fail to teach the use of one or more scrim components, for example scrim layers, especially non-pulp containing scrim components, for example scrim layers, to help retain the pulp fibers within the coform fibrous structure.

As illustrated above, one problem with known scrubby fibrous structures is that the scrubby fibrous structures, especially those that contain solid additives, for example pulp fibers, may lose solid additives, if present, such as in the way of lint or slough, especially during use when a user is scrubbing a surface with the scrubby fibrous structures such that the solid additives present within the fibrous structure tend to become disassociated from and/or dislodged from the scrubby fibrous structures.

Accordingly, there is a need for a scrubby fibrous structure that comprises a scrim component that inhibits, mitigates, and/or prevents loss of solid additives, such as pulp fibers, from the scrubby fibrous structure and methods for making such a scrubby fibrous structures.

### SUMMARY OF THE INVENTION

The present invention fulfills the needs described above by providing a scrubby fibrous structure comprising a scrubby component, a core component, for example a core component comprising solid additives, such as pulp fibers, and additionally a scrim component and methods for making same.

One solution to the problem identified above is to provide scrubby fibrous structures comprising a scrubby component and a core component, especially a core component that contains solid additives, for example pulp fibers, with a scrim component that inhibits, mitigates, and/or prevents the loss of the solid additives from the scrubby fibrous structure, especially during use of the scrubby fibrous structures by a consumer during scrubbing of a surface.

In one example of the present invention, a fibrous structure, for example a scrubby fibrous structure, such as a layered scrubby fibrous structure, comprising one or more core components, one or more scrim components, and one or more scrubby components, is provided.

In another example of the present invention, a fibrous structure, for example a scrubby fibrous structure, such as a layered scrubby fibrous structure, comprising one or more scrim components and one or more core components comprising one or more scrubby components, is provided.

In still another example of the present invention, a fibrous structure, for example a scrubby fibrous structure, such as a layered scrubby fibrous structure, comprising one or more core components and one or more scrim components comprising one or more scrubby components, is provided.

In yet another example of the present invention, a method for making a fibrous structure, for example a scrubby fibrous structure, comprising the steps of:
a. providing a core component, for example a core component comprising a plurality of solid additives;
b. associating a scrim component with at least one surface of the core component; and
c. associating a scrubby component with the scrim component to form a fibrous structure, is provided.

In still another example of the present invention, a method for making a fibrous structure, for example, a scrubby fibrous structure, comprising the steps of:
a. providing a core component, for example a core component comprising a plurality of solid additives;
b. associating a scrim component with one surface of the core component; and
c. associating a scrubby component with the other surface of the core component to form a fibrous structure, is provided.

In still another example of the present invention, a method for making a fibrous structure, for example, a scrubby fibrous structure, comprising the steps of:
a. providing a core component comprising a scrubby component, for example a core component comprising a scrubby component and a plurality of solid additives;
b. associating a scrim component with at least one surface of the core component to form a fibrous structure, is provided.

In still another example of the present invention, a method for making a fibrous structure, for example, a scrubby fibrous structure, comprising the steps of:
a. providing a core component, for example a core component comprising a plurality of solid additives;
b. associating a scrim component comprising a scrubby component with at least one surface of the core component to form a fibrous structure, is provided.

In another example of the present invention, a method for making a fibrous structure, the method comprising the steps of:

a. providing a die;

b. supplying at least a first polymer to the die;

c. producing a plurality of filaments comprising the first polymer from the die;

d. combining the filaments with solid additives to form a mixture;

e. collecting the mixture on a collection device to produce a core component;

f. associating a scrim component with at least one surface of the core component; and

g. associating a scrubby component with the scrim component to form a fibrous structure, is provided.

In another example of the present invention, a method for making a fibrous structure, the method comprising the steps of:

a. providing a die;

b. supplying at least a first polymer to the die;

c. producing a plurality of filaments comprising the first polymer from the die;

d. combining the filaments with solid additives to form a mixture;

e. collecting the mixture on a collection device to produce a core component;

f. associating a scrubby component with at least one surface of the core component; and

g. associating a scrim component with at least one of the core component and the scrubby component to form a fibrous structure, is provided.

In another example of the present invention, a method for making a fibrous structure, the method comprising the steps of:

a. providing a die;

b. supplying at least a first polymer to the die;

c. producing a plurality of filaments comprising the first polymer from the die;

d. combining the filaments with solid additives to form a mixture;

e. combining one or more scrubby components with the mixture to form a scrubby core mixture;

f. collecting the scrubby core mixture on a collection device to produce a core component comprising a scrubby component;

g. associating a scrim component with at least one surface of the core component comprising a scrubby component, is provided.

In one example of the present invention, a process for making a core component for the scrubby fibrous structure, the process comprising the steps of:

a. providing a die comprising one or more filament-forming hole 44s, wherein one or more fluid releasing holes 46 are associated with one filament-forming hole 44 such that a fluid exiting the fluid-releasing hole is parallel or substantially parallel to an exterior surface of a filament exiting the filament-forming hole 44;

b. supplying at least a first polymer to the die;

c. producing a plurality of filaments comprising the first polymer from the die;

d. combining the filaments with solid additives to form a mixture; and

e. collecting the mixture on a collection device to produce a fibrous structure; is provided.

In another example of the present invention, a process for making a core component for the scrubby fibrous structure, the process comprising the steps of:

a. providing a die comprising one or more filament-forming hole 44s, wherein one or more fluid releasing holes 46 are associated with one filament-forming hole 44 such that a fluid exiting the fluid-releasing hole is parallel or substantially parallel to an exterior surface of a filament exiting the filament-forming hole 44;

b. supplying a polyolefin polymer to the die;

c. producing a plurality of filaments comprising the polyolefin polymer from the die;

d. combining the filaments with wood pulp fibers to form a mixture; and

e. collecting the mixture on a collection device to produce a fibrous structure; is provided.

In yet another example of the present invention, a scrubby fibrous structure made by a process according to the present invention is provided.

The present invention provides scrubby fibrous structures and methods for making the same that overcome the negatives of known scrubby fibrous structures.

### BRIEF DESCRIPTION OF THE DRAWINGS

FIG. 1 is a schematic representation of an example of a prior art scrubby fibrous structure;

FIG. 2A is a schematic representation of an example of another prior art scrubby fibrous structure;

FIG. 2B is a schematic representation of an example of another prior art scrubby fibrous structure;

FIG. 3 is a schematic representation of an example of a scrubby fibrous structure according to the present invention;

FIG. 4 is a schematic representation of another example of a scrubby fibrous structure according to the present invention;

FIG. 5 is a schematic representation of another example of a scrubby fibrous structure according to the present invention;

FIG. 6 is a schematic representation of another example of a scrubby fibrous structure according to the present invention;

FIG. 7 is a schematic representation of another example of a scrubby fibrous structure according to the present invention;

FIG. 8 is a schematic representation of another example of a scrubby fibrous structure according to the present invention;

FIG. 9 is a schematic representation of another example of a scrubby fibrous structure according to the present invention;

FIG. 10 is a schematic representation of another example of a scrubby fibrous structure according to the present invention;

FIG. 11 is a schematic representation of another example of a scrubby fibrous structure according to the present invention;

FIG. 12 is a schematic representation of another example of a scrubby fibrous structure according to the present invention;

FIG. 13 is a schematic representation of another example of a scrubby fibrous structure according to the present invention;

FIG. 14 is a schematic representation of another example of a scrubby fibrous structure according to the present invention;

FIG. 15 is a schematic representation of another example of a scrubby fibrous structure according to the present invention;

FIG. 16 is a schematic representation of another example of a scrubby fibrous structure according to the present invention;

FIG. 17 is a schematic representation of another example of a scrubby fibrous structure according to the present invention;

FIG. 18 is a schematic representation of another example of a scrubby fibrous structure according to the present invention;

FIG. 19 is a schematic representation of another example of a scrubby fibrous structure according to the present invention;

FIG. 20 is a schematic representation of another example of a scrubby fibrous structure according to the present invention;

FIG. 21 is a schematic representation of another example of a scrubby fibrous structure according to the present invention;

FIG. 22 is a schematic representation of another example of a scrubby fibrous structure according to the present invention;

FIG. 23 is a schematic representation of another example of a scrubby fibrous structure according to the present invention;

FIG. 24 is a schematic representation of another example of a scrubby fibrous structure according to the present invention;

FIG. 25 is a schematic representation of another example of a scrubby fibrous structure according to the present invention;

FIG. 26 is a schematic representation of another example of a scrubby fibrous structure according to the present invention;

FIG. 27 is a schematic representation of another example of a scrubby fibrous structure according to the present invention;

FIG. 28 is a schematic representation of another example of a scrubby fibrous structure according to the present invention;

FIG. 29 is a schematic representation of another example of a scrubby fibrous structure according to the present invention;

FIG. 30 is a schematic representation of another example of a scrubby fibrous structure according to the present invention;

FIG. 31 is a schematic representation of another example of a scrubby fibrous structure according to the present invention;

FIG. 32A is a top plan view of another example of a scrubby fibrous structure according to the present invention;

FIG. 32B is a perspective view of the scrubby fibrous structure of FIG. 32A;

FIG. 33 is photograph of an example of a fabric used in accordance with the present invention;

FIG. 34 is photograph of another example of a fabric used in accordance with the present invention;

FIG. 35 is a schematic representation of an example of a process for making a scrubby fibrous structure according to the present invention;

FIG. 36 is a schematic representation of an example of a die useful in the processes of the present invention; and

FIG. 37 is a partial, expanded view of the die shown in FIG. 36.

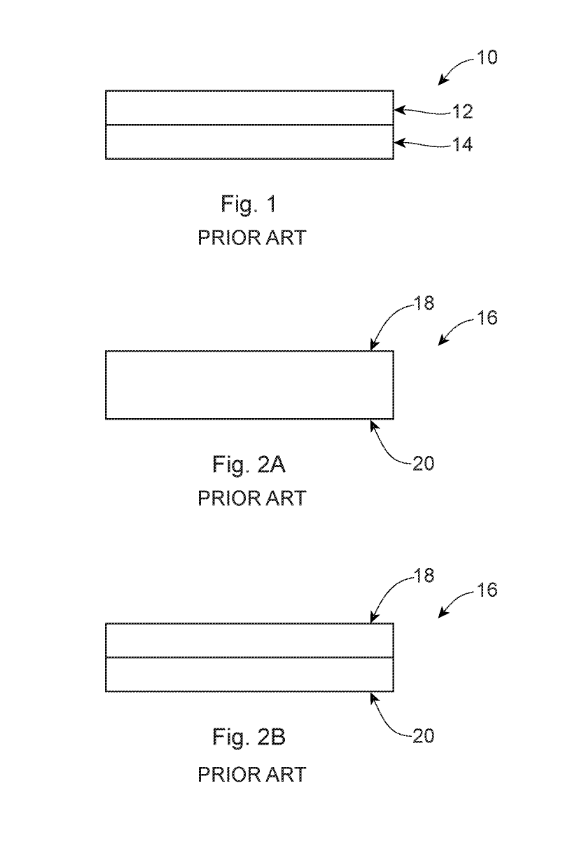

### DETAILED DESCRIPTION OF THE INVENTION

“Fibrous structure” as used herein means a structure that comprises one or more fibrous elements, for example filaments and/or fibers derived from filaments, and optionally one or more solid additives, such as one or more pulp fibers. In one example, a fibrous structure according to the present invention means an orderly arrangement of filaments and optionally fibers within a structure in order to perform a function. In another example, a fibrous structure according to the present invention is a nonwoven.

Non-limiting examples of processes for making fibrous structures include meltblowing and/or spunbonding processes. In one example, the fibrous structures of the present invention are made via a process comprising meltblowing.

The fibrous structures of the present invention may be homogeneous or may be layered. If layered, the fibrous structures may comprise at least two and/or at least three and/or at least four and/or at least five layers.

The fibrous structures of the present invention may be co-formed fibrous structures.

“Co-formed fibrous structure” as used herein means that the fibrous structure comprises a mixture of at least two different materials wherein at least one of the materials comprises a filament, such as a polypropylene filament, and at least one other material, different from the first material, comprises a solid additive, such as a pulp fiber and/or a particulate. In one example, a co-formed fibrous structure comprises solid additives, such as pulp fibers, such as wood pulp fibers, and filaments, such as polypropylene filaments.

“Solid additive” as used herein means a pulp fiber and/or a particulate.

“Particulate” as used herein means a granular substance or powder.

“Fibrous element” as used herein means a filament and/or fiber derived from a filament, for example a staple fiber cut from a filament and/or tow. The fibrous elements are spun, for example via meltblowing and/or spunbonding, from a polymer, for example a thermoplastic polymer, such as polyolefin, for example polypropylene and/or polyethylene, and/or polyester, and/or a non-thermoplastic polymer, such as a hydroxyl polymer, for example polyvinyl alcohol and polysaccharides, such as starch.

“Fiber” and/or “Filament” as used herein means an elongate particulate having an apparent length greatly exceeding its apparent width, i.e. a length to diameter ratio of at least about 10. For purposes of the present invention, a “fiber” is an elongate particulate as described above that exhibits a length of less than 5.08 cm (2 in.) and a “filament” is an elongate particulate as described above that exhibits a length of greater than or equal to 5.08 cm (2 in.). Fibers are typically considered discontinuous in nature. Filaments are typically considered continuous or substantially continuous in nature. Filaments are relatively longer than fibers. Non-limiting examples of filaments include meltblown and/or spunbond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyhydroxy compounds such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments. In one example, the fibrous elements may be spun from sources of cellulose such grasses and grain sources, for example rayon and/or lyocell fibrous elements.

“Pulp fibers” as used herein means fibers that have been derived from vegetative sources, such as plants and/or trees. In one example of the present invention, “pulp fiber” refers to papermaking fibers. Papermaking fibers useful in the present invention include cellulosic pulp fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood pulp fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood pulp fibers. Also applicable to the present invention are pulp fibers derived from recycled paper, which may contain any or all of the above categories as well as other non-fibrous materials such as fillers and adhesives used to facilitate the original papermaking.

In addition to the various wood pulp fibers, other pulp fibers such as cotton linters, trichomes, seed hairs and bagasse can be used in this invention.

“Core component” as used herein means a fibrous structure comprising a plurality of filaments and optionally a plurality of solid additives. In one example, the core component is a coform fibrous structure comprising a plurality of filaments and a plurality of solid additives, for example pulp fibers. In one example, the core component is the component that exhibits the greatest basis weight with the scrubby fibrous structure of the present invention. In one example, the total core components present in the scrubby fibrous structures of the present invention exhibit a basis weight that is greater than 50% and/or greater than 55% and/or greater than 60% and/or greater than 65% and/or greater than 70% and/or less than 100% and/or less than 95% and/or less than 90% of the total basis weight of the scrubby fibrous structure of the present invention as measured according to the Basis Weight Test Method described herein. In another example, the core component exhibits a basis weight of greater than 12 gsm and/or greater than 14 gsm and/or greater than 16 gsm and/or greater than 18 gsm and/or greater than 20 gsm and/or greater than 25 gsm as measured according to the Basis Weight Test Method described herein.

“Consolidated core component” as used herein means a core component where the filaments and optionally the solid additives have been compressed, compacted, and/or packed together with pressure and optionally heat (greater than 150° F.) to strengthen the core component compared to the same core component in its unconsolidated state. In one example, the core component is consolidated by forming an unconsolidated core component on a fabric and/or belt and passing the unconsolidated core component while on the fabric or belt through a pressure nip, such as a heated metal anvil roll (about 275° F.) and a rubber anvil roll with pressure to compress the unconsolidated core component into a consolidated core component. In one example, the consolidated core component exhibits a caliper that is less than the caliper of the unconsolidated core component from which the consolidated core component is derived.

“Unconsolidated core component” as used herein means a core component where the filaments and optionally the solid additives have been loosely arranged in an uncompacted, unpacked arrangement that is less strong that its corresponding consolidated state.

“Core filament” as used herein means one of the filaments that forms the core component.

“Scrim component” as used herein means a fibrous structure comprising a plurality of fibrous elements, for example filaments and/or fibers derived from filaments. In one example, the total scrim components present in the scrubby fibrous structures of the present invention exhibit a basis weight that is less than 25% and/or less than 20% and/or less than 15% and/or less than 10% and/or less than 7% and/or less than 5% and/or greater than 0% and/or greater than 1% of the total basis weight of the scrubby fibrous structure of the present invention as measured according to the Basis Weight Test Method described herein. In another example, the scrim component exhibits a basis weight of 10 gsm or less and/or less than 10 gsm and/or less than 8 gsm and/or less than 6 gsm and/or greater than 5 gsm and/or less than 4 gsm and/or greater than 0 gsm and/or greater than 1 gsm as measured according to the Basis Weight Test Method described herein.

“Scrim fibrous element” as used herein means one of the fibrous elements that forms the scrim component.

“Scrim filament” as used herein means a scrim fibrous element in the form of a filament.

“Scrim fiber” as used herein means a scrim fibrous element in the form of a fiber.

“Scrubby component” as used herein means that part of the scrubby fibrous structure of the present invention that imparts the scrubby quality to the scrubby fibrous structure. The scrubby component is distinct and different from the core and scrim components even though the scrubby component may be present in and/or on the core and scrim components. The scrubby component may be a feature, such as a pattern, for example a surface pattern, or texture that causes the scrubby fibrous structure to exhibit a scrubby property during use by a consumer. In another example, the scrubby component may be a material, for example a coarse fibrous element (exhibits a greater average diameter than the majority of fibrous elements and/or filaments within the core and/or scrim components). In one example, the scrubby component is a fibrous structure comprising a plurality of fibrous elements, for example filaments and/or fibers derived from filaments. In one example, the total scrubby components present in the scrubby fibrous structures of the present invention exhibit a basis weight that is less than 25% and/or less than 20% and/or less than 15% and/or less than 10% and/or less than 7% and/or less than 5% and/or greater than 0% and/or greater than 1% of the total basis weight of the scrubby fibrous structure of the present invention as measured according to the Basis Weight Test Method described herein. In another example, the scrubby component exhibits a basis weight of 10 gsm or less and/or less than 10 gsm and/or less than 8 gsm and/or less than 6 gsm and/or greater than 5 gsm and/or less than 4 gsm and/or greater than 0 gsm and/or greater than 1 gsm as measured according to the Basis Weight Test Method described herein.

“Scrubby element” as used herein means the particular feature and/or material that imparts the scrubby quality to another component, such as a core component and/or scrim component.

“Scrubby fibrous element” as used herein means one of the fibrous elements that forms scrubby component.

“Scrubby filament” as used herein means a scrubby fibrous element in the form of a filament.

“Scrubby fiber” as used herein means a scrubby fibrous element in the form of a fiber.

“Distinct from” and/or different from” as used herein means two things that exhibit different properties, different materials, different average fiber diameters.

“Textured pattern” as used herein means a pattern, for example a surface pattern, such as a three-dimensional (3D) surface pattern present a surface of the scrubby fibrous structure and/or on a surface of a component making up the scrubby fibrous structure.

“Basis Weight” as used herein is the weight per unit area of a sample reported in lbs/3000 ft² or g/m² and is measured according to the Basis Weight Test Method described herein.

“Ply” as used herein means an individual, integral fibrous structure.

“Plies” as used herein means two or more individual, integral fibrous structures disposed in a substantially contiguous, face-to-face relationship with one another, forming a multi-ply sanitary tissue product. It is also contemplated that an individual, integral fibrous structure can effectively form a multi-ply sanitary tissue product, for example, by being folded on itself.

“Total Pore Volume” as used herein means the sum of the fluid holding void volume in each pore range from 1 μm to 1000 μm radii as measured according to the Pore Volume Test Method described herein.

“Pore Volume Distribution” as used herein means the distribution of fluid holding void volume as a function of pore radius. The Pore Volume Distribution of a fibrous structure is measured according to the Pore Volume Test Method described herein.

“Machine Direction” or “MD” as used herein means the direction parallel to the flow of the scrubby fibrous structure through the scrubby fibrous structure making machine and/or manufacturing equipment.

“Cross Machine Direction” or “CD” as used herein means the direction parallel to the width of the scrubby fibrous structure through the scrubby fibrous structure making machine and/or manufacturing equipment and perpendicular to the machine direction.

### Fibrous Structure

The scrubby fibrous structure of the present invention comprises one or more core components (consolidated and/or unconsolidated), one or more scrim components, and one or more scrubby components. The components may be present in the scrubby fibrous structure in any arrangement so long as the scrubby fibrous structure exhibits a scrubby quality to a user of the scrubby fibrous structure. In one example, the core component comprises a scrubby component, for example a scrubby element. In another example, the scrim component comprises a scrubby component, for example a scrubby element.

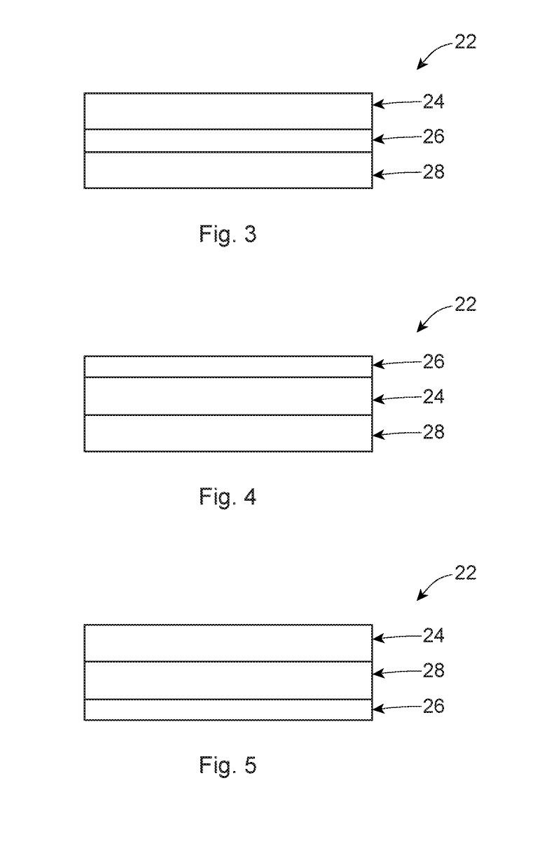

In one example as shown in FIG. 3, the scrubby fibrous structure 22 is a multi-layered fibrous structure comprising a first layer comprising a core component 28, a second layer comprising a scrubby component 24, and a third layer comprising a scrim component 26 positioned between the core component 28 and the scrubby component 24.

In another example as shown in FIG. 4, the scrubby fibrous structure 22 is a multi-layered fibrous structure comprising a first layer comprising a core component 28, a second layer comprising a scrim component 26, and a third layer comprising a scrubby component 24 positioned between the core component 28 and the scrim component 26.

In another example as shown in FIG. 5, the scrubby fibrous structure 22 is a multi-layered fibrous structure comprising a first layer comprising a core component 28 positioned between a second layer comprising a scrim component 26, and a third layer comprising a scrubby component 24.

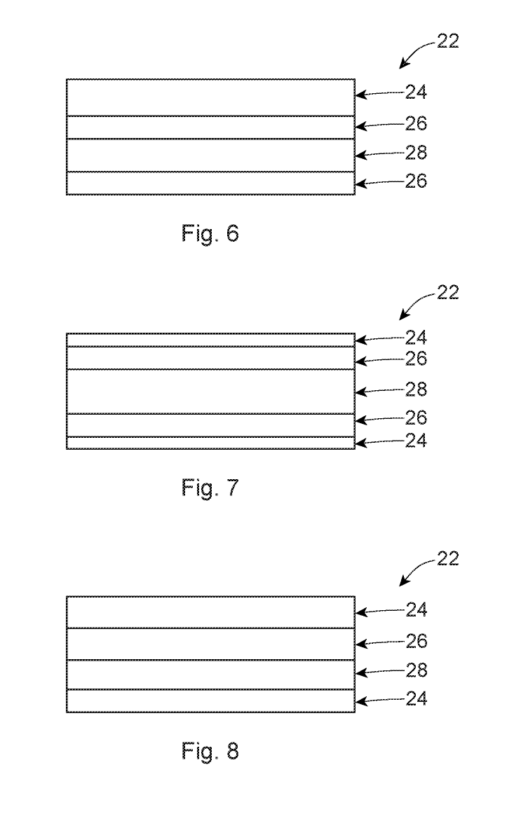

In another example as shown in FIG. 6, the scrubby fibrous structure 22 is a multi-layered fibrous structure comprising a first layer comprising a core component 28, a second layer comprising a scrubby component 24, and a third layer comprising a scrim component 26 positioned between the core component 28 and the scrubby component 24, and a fourth layer comprising another scrim component 26 such that the core component 28 is positioned between the two scrim components 26.

In another example as shown in FIG. 7, the scrubby fibrous structure 22 is a multi-layered fibrous structure comprising a first layer comprising a core component 28, a second layer comprising a scrubby component 24, and a third layer comprising a scrim component 26 positioned between the core component 28 and the scrubby component 24, and a fourth layer comprising another scrim component 26 such that the core component 28 is positioned between the two scrim components 26 and additionally a fifth layer comprising another scrubby component 24 such that the two scrubby components 24 form the exterior layers of the scrubby fibrous structure 22.

In another example as shown in FIG. 8, the scrubby fibrous structure 22 is a multi-layered fibrous structure comprising a first layer comprising a core component 28, a second layer comprising a scrubby component 24, and a third layer comprising a scrim component 26 positioned between the core component 28 and the scrubby component 24, and a fourth layer comprising another scrubby component 24 such that the core component 28 is positioned between the scrim component 26 and the scrubby component 24.

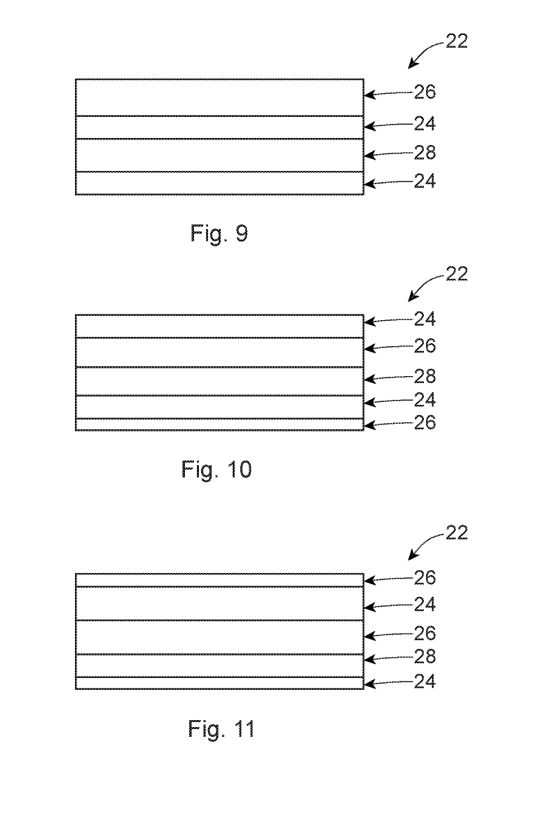

In another example as shown in FIG. 9, the scrubby fibrous structure 22 is a multi-layered fibrous structure comprising a first layer comprising a core component 28, a second layer comprising a scrim component 26, and a third layer comprising a scrubby component 24 positioned between the core component 28 and the scrim component 26, and a fourth layer comprising another scrubby component 24 such that the core component 28 is positioned between the two scrubby components 24.

In another example as shown in FIGS. 10 and 11, the scrubby fibrous structure 22 is a multi-layered fibrous structure comprising a first layer comprising a core component 28, a second layer comprising a scrubby component 24, and a third layer comprising a scrim component 26 positioned between the core component 28 and the scrubby component 24, and a fourth layer comprising another scrubby component 24 such that the core component 28 is positioned between the scrim component 26 and the scrubby component 24 and additionally a fifth layer comprising another scrim component 26 such that one scrubby component 24 and one scrim component 26 form the exterior layers of the scrubby fibrous structure 22.

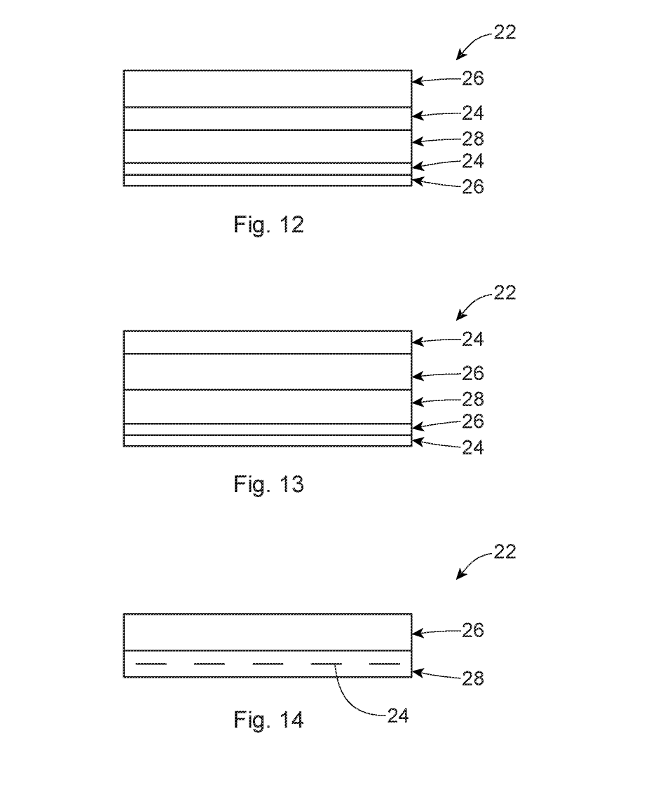

In another example as shown in FIG. 12, the scrubby fibrous structure 22 is a multi-layered fibrous structure comprising a first layer comprising a core component 28, a second layer comprising a scrim component 26, and a third layer comprising a scrubby component 24 positioned between the core component 28 and the scrim component 26, and a fourth layer comprising another scrubby component 24 such that the core component 28 is positioned between the two scrubby components 24 and additionally a fifth layer comprising another scrim component 26 such that the two scrim components 26 form the exterior layers of the scrubby fibrous structure 22.

In another example as shown in FIG. 13, the scrubby fibrous structure 22 is a multi-layered fibrous structure comprising a first layer comprising a core component 28, a second layer comprising a scrubby component 24, and a third layer comprising a scrim component 26 positioned between the core component 28 and the scrubby component 24, and a fourth layer comprising another scrim component 26 such that the core component 28 is positioned between the two scrim components 26 and additionally a fifth layer comprising another scrubby component 24 such that the two scrubby components 24 form the exterior layers of the scrubby fibrous structure 22.

In one example as shown in FIG. 14, the scrubby fibrous structure 22 is a multi-layered fibrous structure comprising a first layer comprising a core component 28 comprising a scrubby component 24, for example a scrubby element, such as a scrubby fibrous element, in this case scrubby fibers, and a second layer comprising a scrim component 26.

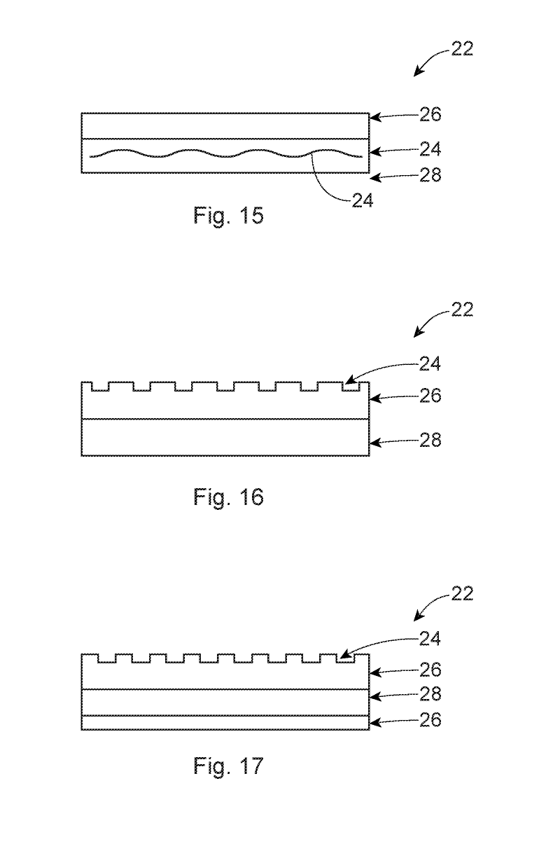

In one example as shown in FIG. 15, the scrubby fibrous structure 22 is a multi-layered fibrous structure comprising a first layer comprising a core component 28 comprising a scrubby component 24, for example a scrubby element, such as a scrubby fibrous element, in this case scrubby filaments, and a second layer comprising a scrim component 26.

In another example as shown in FIG. 16, the scrubby fibrous structure 22 is a multi-layered fibrous structure comprising a first layer comprising a core component 28, a second layer comprising a scrim component 26 comprising a scrubby component 24, for example a scrubby element, such as a pattern, for example a surface pattern.

In one example as shown in FIG. 17, the scrubby fibrous structure 22 is a multi-layered fibrous structure comprising a first layer comprising a core component 28, a second layer comprising a scrim component 26 comprising a scrubby component 24, for example a scrubby element, such as a pattern, for example a surface pattern, and a third layer comprising another scrim component 26 such that the two scrim components 26 form the exterior layers of the scrubby fibrous structure 22.

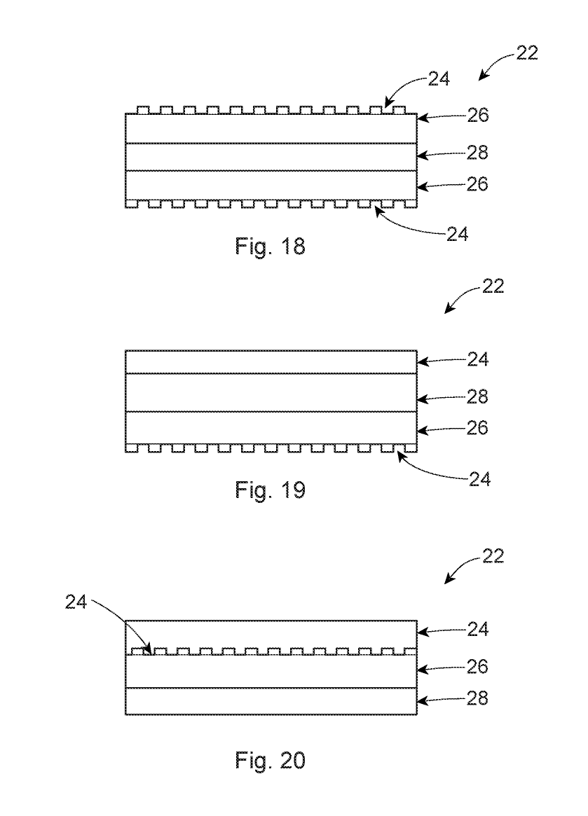

In another example as shown in FIG. 18, the scrubby fibrous structure 22 is a multi-layered fibrous structure comprising a first layer comprising a core component 28 positioned between a second layer comprising a scrim component 26 comprising a scrubby component 24, such as a pattern, for example a surface pattern, and a third layer comprising another scrim component 26 comprising a scrubby component 24, such as a pattern, for example a surface pattern, such that the two scrim components 26 form the exterior layers of the scrubby fibrous structure 22.

In another example as shown in FIG. 19, the scrubby fibrous structure 22 is a multi-layered fibrous structure comprising a first layer comprising a core component 28 positioned between a second layer comprising a scrim component 26 comprising a scrubby component 24, such as a pattern, for example a surface pattern, and a third layer comprising a scrubby component 24 such that the scrim component 26 and the scrubby component 24 form the exterior layers of the scrubby fibrous structure 22.

In another example as shown in FIG. 20, the scrubby fibrous structure 22 is a multi-layered fibrous structure comprising a first layer comprising a core component 28, a second layer comprising a scrubby component 24, and a third layer comprising a scrim component 26 comprising a scrubby component 24, such as a pattern, for example a surface pattern, positioned between the core component 28 and the scrubby component 24.

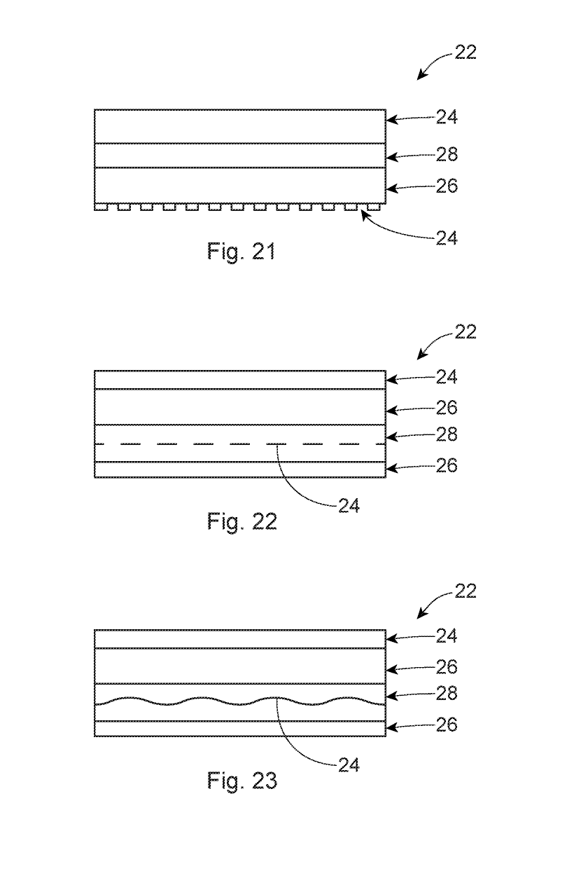

In another example as shown in FIG. 21, the scrubby fibrous structure 22 is a multi-layered fibrous structure comprising a first layer comprising a core component 28, a second layer comprising a scrubby component 24, and a third layer comprising a scrim component 26 comprising a scrubby component 24, for example a scrubby element, such as a pattern, for example a surface pattern, such that the core component 28 is positioned between the scrim component 26 and the scrubby component 24.

In another example as shown in FIG. 22, the scrubby fibrous structure 22 is a multi-layered fibrous structure comprising a first layer comprising a core component 28 comprising a scrubby component 24, for example a scrubby element, such as a scrubby fibrous element, for example scrubby fibers, a second layer comprising a scrubby component 24, and a third layer comprising a scrim component 26 positioned between the core component 28 and the scrubby component 24, and a fourth layer comprising another scrim component 26 such that the core component 28 is positioned between the two scrim components 26.

In another example as shown in FIG. 23, the scrubby fibrous structure 22 is a multi-layered fibrous structure comprising a first layer comprising a core component 28 comprising a scrubby component 24, for example a scrubby element, such as a scrubby fibrous element, for example scrubby filaments, a second layer comprising a scrubby component 24, and a third layer comprising a scrim component 26 positioned between the core component 28 and the scrubby component 24, and a fourth layer comprising another scrim component 26 such that the core component 28 is positioned between the two scrim components 26.

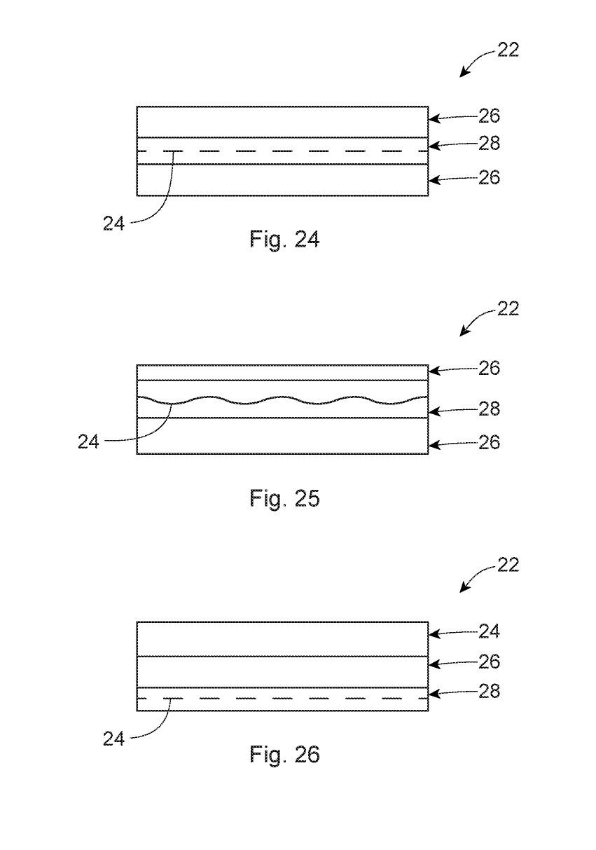

In another example as shown in FIG. 24, the scrubby fibrous structure 22 is a multi-layered fibrous structure comprising a first layer comprising a core component 28 comprising a scrubby component 24, such as a scrubby element, for example a scrubby fibrous element, such as scrubby fibers, positioned between two layers of scrim components 26.

In another example as shown in FIG. 25, the scrubby fibrous structure 22 is a multi-layered fibrous structure comprising a first layer comprising a core component 28 comprising a scrubby component 24, such as a scrubby element, for example a scrubby fibrous element, such as scrubby filaments, positioned between two layers of scrim components 26.

In another example as shown in FIG. 26, the scrubby fibrous structure 22 is a multi-layered fibrous structure comprising a first layer comprising a core component 28 comprising a scrubby component 24, such as a scrubby element, for example a scrubby fibrous element, such as scrubby fibers, and a second layer comprising a scrubby component 24, and a third layer comprising a scrim component 26 (optionally comprising a scrubby component 24) positioned between the core component 28 and the scrubby component 24.

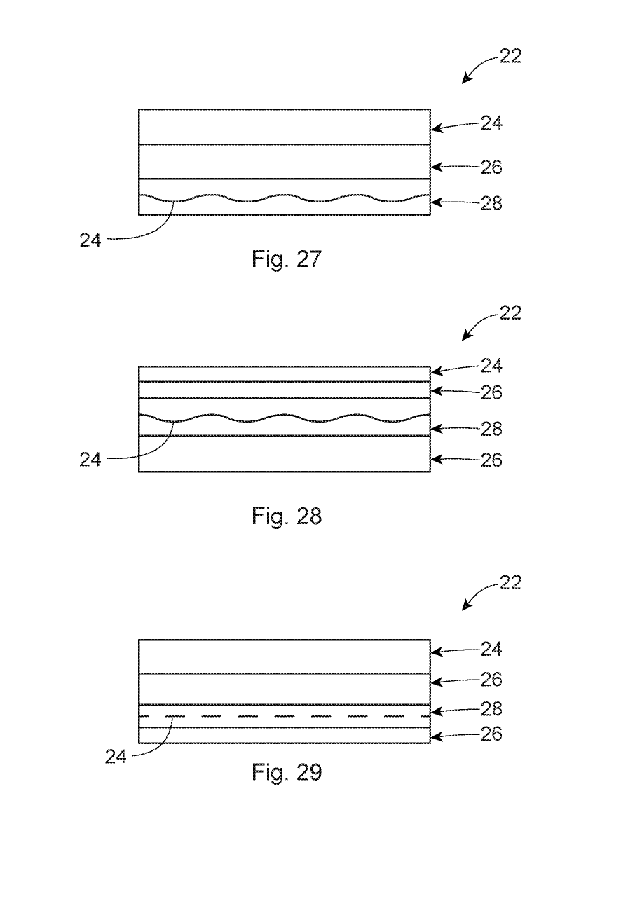

In another example as shown in FIG. 27, the scrubby fibrous structure 22 is a multi-layered fibrous structure comprising a first layer comprising a core component 28 comprising a scrubby component 24, such as a scrubby element, for example a scrubby fibrous element, such as scrubby filaments, and a second layer comprising a scrubby component 24, and a third layer comprising a scrim component 26 (optionally comprising a scrubby component 24) positioned between the core component 28 and the scrubby component 24.

In another example as shown in FIG. 28, the scrubby fibrous structure 22 is a multi-layered fibrous structure comprising a first layer comprising a core component 28 comprising a scrubby component 24, such as a scrubby element, for example a scrubby fibrous element, such as scrubby filaments, and a second layer comprising a scrubby component 24, and a third layer comprising a scrim component 26 (optionally comprising a scrubby component 24) positioned between the core component 28 and the scrubby component 24, and a fourth layer comprising another scrim component 26 (optionally comprising a scrubby component 24) such that the core component 28 is positioned between the two scrim components 26.

In another example as shown in FIG. 29, the scrubby fibrous structure 22 is a multi-layered fibrous structure comprising a first layer comprising a core component 28 comprising a scrubby component 24, such as a scrubby element, for example a scrubby fibrous element, such as scrubby fibers, and a second layer comprising a scrubby component 24, and a third layer comprising a scrim component 26 (optionally comprising a scrubby component 24) positioned between the core component 28 and the scrubby component 24, and a fourth layer comprising another scrim component 26 (optionally comprising a scrubby component 24) such that the core component 28 is positioned between the two scrim components 26.

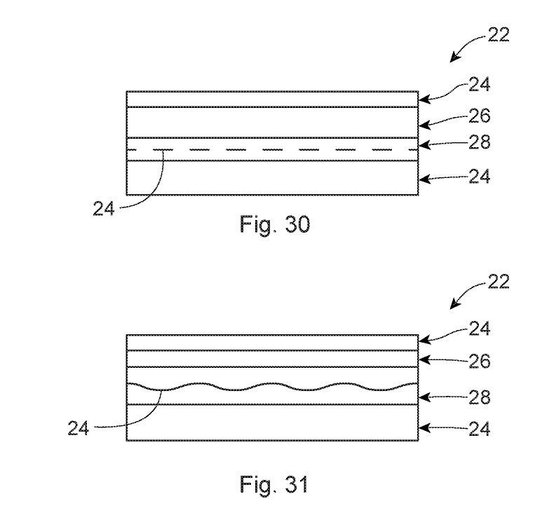

In another example as shown in FIG. 30, the scrubby fibrous structure 22 is a multi-layered fibrous structure comprising a first layer comprising a core component 28 comprising a scrubby component 24, such as a scrubby element, for example a scrubby fibrous element, such as scrubby fibers, and a second layer comprising a scrubby component 24, and a third layer comprising a scrim component 26 (optionally comprising a scrubby component 24) positioned between the core component 28 and the scrubby component 24, and a fourth layer comprising another scrubby component 24 such that the two scrubby components 24 form the exterior layers of the scrubby fibrous structure 22.

In another example as shown in FIG. 31, the scrubby fibrous structure 22 is a multi-layered fibrous structure comprising a first layer comprising a core component 28 comprising a scrubby component 24, such as a scrubby element, for example a scrubby fibrous element, such as scrubby filaments, and a second layer comprising a scrubby component 24, and a third layer comprising a scrim component 26 (optionally comprising a scrubby component 24) positioned between the core component 28 and the scrubby component 24, and a fourth layer comprising another scrubby component 24 such that the two scrubby components 24 form the exterior layers of the scrubby fibrous structure 22.

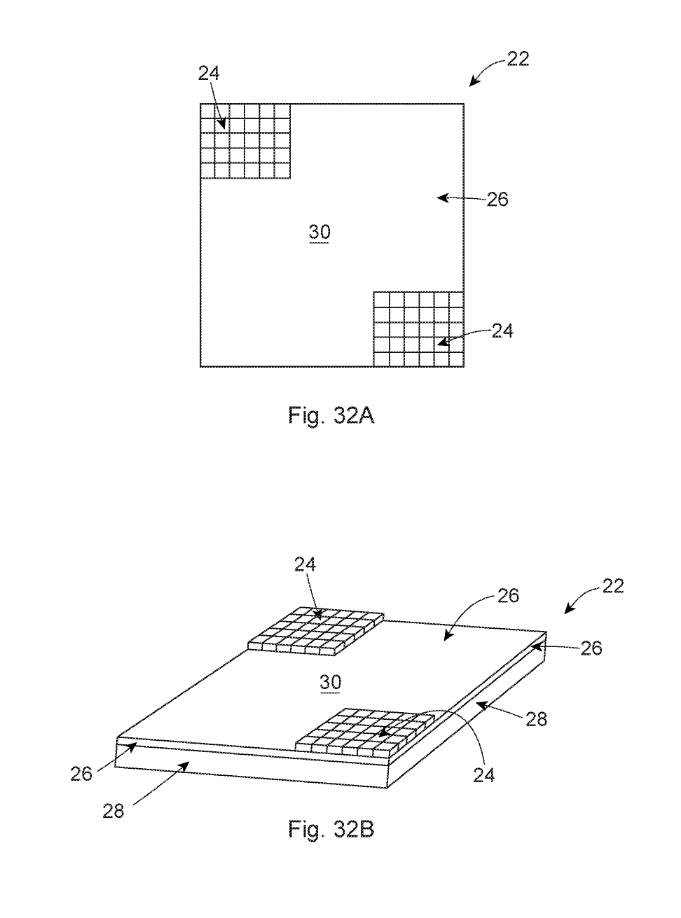

As shown in FIGS. 32A and 32B, the scrubby fibrous structures 22 of the present invention may comprise one or more regions/zones of scrubby components 24 and one or more regions/zones void of scrubby components 30, for example scrim components 26. In one example, the one or more regions of scrubby components 24 may comprise scrubby components 24 that are present within a core component 28, for example as a scrubby element, and/or on the surface of a scrim component 26, for example as a surface pattern or partial surface pattern on the surface of the scrim component 26.

In one example, a fibrous structure, for example a scrubby fibrous structure, according to the present invention comprises:

a. one or more core components;

b. one or more scrim components; and

c. one or more scrubby components;

wherein the components are different from one another.

In one example, at least one of the core components of the scrubby fibrous structure comprises a plurality of solid additives, for example pulp fibers, such as comprise wood pulp fibers and/or non-wood pulp fibers.

In one example, at least one of the core components of the scrubby fibrous structure comprises a plurality of core filaments. In another example, at least one of the core components comprises a plurality of solid additives and a plurality of the core filaments. In one example, the solid additives and the core filaments are present in a layered orientation within the core component. In one example, the core filaments are present as a layer between two solid additive layers. In another example, the solid additives and the core filaments are present in a coform layer. At least one of the core filaments comprises a polymer, for example a thermoplastic polymer, such as a polyolefin. The polyolefin may be selected from the group consisting of: polypropylene, polyethylene, and mixtures thereof. In another example, the thermoplastic polymer of the core filament may comprise a polyester.

In yet another example, the core filament may comprise a hydroxyl polymer, for example a hydroxyl polymer selected from the group consisting of: polyvinyl alcohol, starch, starch derivatives, starch copolymers, chitosan, chitosan derivatives, chitosan copolymers, cellulose, cellulose derivatives, cellulose copolymers, hemicellulose, hemicellulose derivatives, hemicellulose copolymers, and mixtures thereof. In another example, the hydroxyl polymer may be selected from the group consisting of: starch, starch derivatives, starch copolymers, chitosan, chitosan derivatives, chitosan copolymers, cellulose, cellulose derivatives, cellulose copolymers, hemicellulose, hemicellulose derivatives, hemicellulose copolymers, and mixtures thereof.

The average fiber diameter of the core filaments is less than 250 and/or less than 200 and/or less than 150 and/or less than 100 and/or less than 50 and/or less than 25 and/or less than 10 and/or greater than 1 and/or greater than 3 μm as measured according to the Diameter Test Method described herein.

In one example, at least one of the core components comprises one or more scrubby components, for example a scrubby element, such as a scrubby fibrous element, for example a scrubby fiber and/or a scrubby filament. In one example, the scrubby fibrous elements comprise a polymer, for example a thermoplastic polymer and/or hydroxyl polymer as described above with reference to the core components.

In one example, the scrubby fibrous elements exhibit an average fiber diameter of less than 3 mm and/or less than 2 mm and/or less than 1 mm and/or less than 750 μm and/or less than 500 μm and/or less than 250 μm and/or greater than 50 μm and/or greater than 75 μm and/or greater than 100 μm as measured according to the Diameter Test Method described herein.

In one example, at least one of the scrim components is adjacent to at least one of the core components within the scrubby fibrous structure. In another example, at least one of the core components is positioned between two scrim components within the scrubby fibrous structure.

In one example, at least one of the scrim components of the scrubby fibrous structure of the present invention comprises a plurality of scrim fibrous elements, for example scrim filaments, wherein the scrim filaments comprise a polymer, for example a thermoplastic and/or hydroxyl polymer as described above with reference to the core components.

In one example, at least one of the scrim fibrous elements exhibits an average fiber diameter of less than 50 and/or less than 25 and/or less than 10 and/or at least 0.01 (10 nm) and/or greater than 1 and/or greater than 3 μm as measured according to the Diameter Test Method described herein.

In one example, at least one of the scrim components of the scrubby fibrous structures of the present invention comprises one or more scrubby components, for example a scrubby element, such as a scrubby fibrous element, which may be a scrubby filament or a scrubby fiber or mixture thereof. In one example, the scrubby fibrous elements comprise a polymer, for example a thermoplastic polymer and/or hydroxyl polymer as described above with reference to the core components.

In one example, the scrubby fibrous elements exhibit an average fiber diameter of less than 250 and/or less than 200 and/or less than 150 and/or less than 120 and/or less than 100 and/or 75 and/or less than 50 and/or less than 40 and/or less than 30 and/or less than 25 and/or greater than 0.6 and/or greater than 1 and/or greater than 3 and/or greater than 5 and/or greater than 10 μm as measured according to the Diameter Test Method described herein.

In another example, the scrubby element of the scrim component may comprise a pattern, for example a surface pattern, such as a textured pattern, present on a surface of the scrim component. The pattern may comprise a non-random, repeating pattern. The pattern may comprise a belt-imparted pattern. The pattern may comprise a fabric-imparted pattern.

In one example, at least one of the scrubby components of the scrubby fibrous structure of the present invention comprises a plurality of scrubby fibrous elements, for example a scrubby fiber and/or a scrubby filament. In one example, the scrubby fibrous elements comprise a polymer, for example a thermoplastic polymer and/or hydroxyl polymer as described above with reference to the core components.

In one example, the scrubby fibrous elements exhibit an average fiber diameter of less than 250 and/or less than 200 and/or less than 150 and/or less than 120 and/or less than 100 and/or 75 and/or less than 50 and/or less than 40 and/or less than 30 and/or less than 25 and/or greater than 0.6 and/or greater than 1 and/or greater than 3 and/or greater than 5 and/or greater than 10 μm μm as measured according to the Diameter Test Method described herein.

In one example, the scrubby component may comprise a pattern, for example a textured pattern, of the scrubby fibrous elements. The pattern may comprise a non-random, repeating pattern. The pattern may comprise a belt-imparted pattern. The pattern may comprise a fabric-imparted pattern. In one example, the scrubby fibrous elements of the scrubby component may be present on a surface of one or more of the scrim components and/or on a surface of one or more of the core components.

In one example, at least one of the scrubby components of the scrubby fibrous structure of the present invention is oriented such that it forms an exterior surface of the fibrous structure.

In another example, at least one of the scrubby components of the scrubby fibrous structure of the present invention is oriented such that it forms an interior component of the fibrous structure.

In one example, at least one of the scrim components of the scrubby fibrous structure of the present invention is oriented such that it forms an exterior surface of the fibrous structure.

In another example, at least one of the scrim components of the scrubby fibrous structure of the present invention is oriented such that it forms an interior component of the fibrous structure.

In one example, at least one of the core components of the scrubby fibrous structure of the present invention is oriented such that it forms an exterior surface of the fibrous structure.

In another example, at least one of the core components of the scrubby fibrous structure of the present invention is oriented such that it forms an interior component of the fibrous structure.

In one example, at least one of the scrim components of the scrubby fibrous structure of the present invention is positioned between one of the scrubby components and one of the core components.

In one example, at least one of the scrubby components of the scrubby fibrous structure of the present invention is positioned between one of the scrim components and one of the core components.

In another example, at least one of the scrubby components of the scrubby fibrous structure of the present invention is positioned between two of the core components.

In one example, at least one of the core components of the scrubby fibrous structure of the present invention is positioned between one of the scrubby components and one of the scrim components.

In another example, at least one of the core components of the scrubby fibrous structure of the present invention is positioned between two of the scrim components.

In one example, at least one of the scrubby components of the scrubby fibrous structure of the present invention is positioned between two of the scrim components.

In one example, at least one of the scrim components of the scrubby fibrous structure of the present invention is positioned between two of the core components.

In one example, at least one of the core components of the scrubby fibrous structure of the present invention comprises a consolidated core component.

In one example, at least one of the core components of the scrubby fibrous structure of the present invention comprises an unconsolidated core component.

In one example, the fibrous structures of the present invention may comprise any suitable amount of filaments and any suitable amount of solid additives. For example, the fibrous structures may comprise from about 10% to about 70% and/or from about 20% to about 60% and/or from about 30% to about 50% by dry weight of the fibrous structure of filaments and from about 90% to about 30% and/or from about 80% to about 40% and/or from about 70% to about 50% by dry weight of the fibrous structure of solid additives, such as wood pulp fibers.

In one example, the filaments and solid additives of the present invention may be present in fibrous structures according to the present invention at weight ratios of filaments to solid additives of from at least about 1:1 and/or at least about 1:1.5 and/or at least about 1:2 and/or at least about 1:2.5 and/or at least about 1:3 and/or at least about 1:4 and/or at least about 1:5 and/or at least about 1:7 and/or at least about 1:10.

In one example, the solid additives, for example wood pulp fibers, may be selected from the group consisting of softwood kraft pulp fibers, hardwood pulp fibers, and mixtures thereof. Non-limiting examples of hardwood pulp fibers include fibers derived from a fiber source selected from the group consisting of: Acacia, Eucalyptus, Maple, Oak, Aspen, Birch, Cottonwood, Alder, Ash, Cherry, Elm, Hickory, Poplar, Gum, Walnut, Locust, Sycamore, Beech, Catalpa, Sassafras, Gmelina, Albizia, Anthocephalus, and Magnolia. Non-limiting examples of softwood pulp fibers include fibers derived from a fiber source selected from the group consisting of: Pine, Spruce, Fir, Tamarack, Hemlock, Cypress, and Cedar. In one example, the hardwood pulp fibers comprise tropical hardwood pulp fibers. Non-limiting examples of suitable tropical hardwood pulp fibers include Eucalyptus pulp fibers, Acacia pulp fibers, and mixtures thereof.

In one example, the hardwood pulp fibers exhibit a Kajaani fiber cell wall thickness of less than 5.98 μm and/or less than 5.96 μm and/or less than 5.94 μm. In another example, the hardwood pulp fibers exhibit a Kajaani fiber width of less than 14.15 μm and/or less than 14.10 μm and/or less than 14.05 μm and/or less than 14.00 μm and/or less than 13.95 μm and/or less than 13.90 μm. In another example, the hardwood pulp fibers exhibit a Kajaani millions of fibers/gram of greater than 24 millions of fibers/gram and/or greater than 20.5 millions of fibers/gram and/or greater than 21 millions of fibers/gram and/or greater than 21.5 millions of fibers/gram and/or greater than 22 millions of fibers/gram and/or greater than 22.5 millions of fibers/gram and/or greater than 23 millions of fibers/gram and/or greater than 23.5 millions of fibers/gram and/or greater than 24 millions of fibers/gram and/or greater than 24.5 millions of fibers/gram and/or greater than 25 millions of fibers/gram. In still another example, the hardwood pulp fibers exhibit a Kajaani fiber cell wall thickness of less than 6.15 μm and/or less than 6.10 μm and/or less than 6.05 μm and/or less than 6.00 μm and/or less than 5.98 μm and/or less than 5.96 μm and/or less than 5.94 μm. In even still another example, the hardwood pulp fibers exhibit a ratio of Kajaani fiber length (μm) to Kajaani fiber width (μm) of less than 45 and/or less than 43 and/or less than 41. In still yet another example, the hardwood pulp fibers exhibit a ratio of Kajaani fiber coarseness of less than 0.074 mg/m and/or less than 0.0735 mg/m

In one example, the wood pulp fibers comprise softwood pulp fibers derived from the kraft process and originating from southern climates, such as Southern Softwood Kraft (SSK) pulp fibers. In another example, the wood pulp fibers comprise softwood pulp fibers derived from the kraft process and originating from northern climates, such as Northern Softwood Kraft (NSK) pulp fibers.

The wood pulp fibers present in the fibrous structure may be present at a weight ratio of softwood pulp fibers to hardwood pulp fibers of from 100:0 and/or from 90:10 and/or from 86:14 and/or from 80:20 and/or from 75:25 and/or from 70:30 and/or from 60:40 and/or about 50:50 and/or to 0:100 and/or to 10:90 and/or to 14:86 and/or to 20:80 and/or to 25:75 and/or to 30:70 and/or to 40:60. In one example, the weight ratio of softwood pulp fibers to hardwood pulp fibers is from 86:14 to 70:30.

In one example, the fibrous structures of the present invention comprise one or more trichomes. Non-limiting examples of suitable sources for obtaining trichomes, especially trichome fibers, are plants in the Labiatae (Lamiaceae) family commonly referred to as the mint family. Examples of suitable species in the Labiatae family include Stachys byzantina, also known as Stachys lanata commonly referred to as lamb's ear, woolly betony, or woundwort. The term Stachys byzantina as used herein also includes cultivars Stachys byzantina ‘Primrose Heron’, Stachys byzantina ‘Helene von Stein’ (sometimes referred to as Stachys byzantina ‘Big Ears’), Stachys byzantina ‘Cotton Boll’, Stachys byzantina ‘Variegated’ (sometimes referred to as Stachys byzantina ‘Striped Phantom’), and Stachys byzantina ‘Silver Carpet’.

In another example, the fibrous structure of the present invention, alone or as a ply of fibrous structure in a multi-ply fibrous structure, comprises a creped fibrous structure. The creped fibrous structure may comprise a fabric creped fibrous structure, a belt creped fibrous structure, and/or a cylinder creped, such as a cylindrical dryer creped fibrous structure. In one example, the fibrous structure may comprise undulations and/or a surface comprising undulations.

In yet another example, the fibrous structure of the present invention, alone or as a ply of fibrous structure in a multi-ply fibrous structure, comprises an uncreped fibrous structure.

In still another example, the fibrous structure of the present invention, alone or as a ply of fibrous structure in a multi-ply fibrous structure, comprises a foreshortened fibrous structure.

In another example of a fibrous structure in accordance with the present invention, instead of being layers of fibrous structure, the material forming layers may be in the form of plies wherein two or more of the plies may be combined to form a multi-ply fibrous structure. The plies may be bonded together, such as by thermal bonding and/or adhesive bonding, to form the multi-ply fibrous structure. After a bonding operation, especially a thermal bonding operation, it may be difficult to distinguish the plies of the fibrous structure and the fibrous structure may visually and/or physically be a similar to a layered fibrous structure in that one would have difficulty separating the once individual plies from each other.

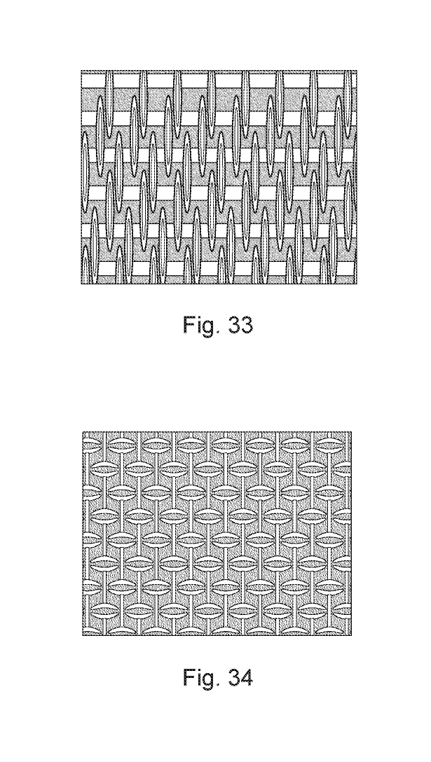

At least one or more of the fibrous structure layers (components) and/or plies may comprise two or more regions that exhibit different values of a common intensive property, for example different densities. Such regions may be imparted to the fibrous structure layers (components) and/or plies by passing the fibrous structure being carried on a porous belt or fabric, such as a forming fabric through a nip formed by two rollers, such as a heated steel roll and a rubber roll, that causes portions of the fibrous structure to be deflected into one or more pores of the porous belt or fabric. This deflection results in the fibrous structure exhibiting two or more regions of different values of a common intensive property. Non-limiting examples of suitable fabrics for use in this process are commercially available from Albany International under trade names such as VeloStat, for example VeloStat 170PC740 as shown in FIG. 33, ElectroTech, for example ElectroTech 100S as shown in FIG. 34, and MicroStat.

The fibrous structures of the present invention and/or any sanitary tissue products comprising such fibrous structures may be subjected to any post-processing operations such as embossing operations, printing operations, tuft-generating operations, thermal bonding operations, ultrasonic bonding operations, perforating operations, surface treatment operations such as application of lotions, silicones and/or other materials and mixtures thereof.

Non-limiting examples of suitable polypropylenes for making the filaments of the present invention are commercially available from Lyondell-Basell and Exxon-Mobil.

Any hydrophobic or non-hydrophilic materials within the fibrous structure, such as polypropylene filaments, may be surface treated and/or melt treated with a hydrophilic modifier. Non-limiting examples of surface treating hydrophilic modifiers include surfactants, such as Triton X-100. Non-limiting examples of melt treating hydrophilic modifiers that are added to the melt, such as the polypropylene melt, prior to spinning filaments, include hydrophilic modifying melt additives such as VW351 and/or S-1416 commercially available from Polyvel, Inc. and Irgasurf commercially available from Ciba. The hydrophilic modifier may be associated with the hydrophobic or non-hydrophilic material at any suitable level known in the art. In one example, the hydrophilic modifier is associated with the hydrophobic or non-hydrophilic material at a level of less than about 20% and/or less than about 15% and/or less than about 10% and/or less than about 5% and/or less than about 3% to about 0% by dry weight of the hydrophobic or non-hydrophilic material.

The fibrous structures of the present invention may include optional additives, each, when present, at individual levels of from about 0% and/or from about 0.01% and/or from about 0.1% and/or from about 1% and/or from about 2% to about 95% and/or to about 80% and/or to about 50% and/or to about 30% and/or to about 20% by dry weight of the fibrous structure. Non-limiting examples of optional additives include permanent wet strength agents, temporary wet strength agents, dry strength agents such as carboxymethylcellulose and/or starch, softening agents, lint reducing agents, opacity increasing agents, wetting agents, odor absorbing agents, perfumes, temperature indicating agents, color agents, dyes, osmotic materials, microbial growth detection agents, antibacterial agents and mixtures thereof.

The fibrous structure of the present invention may itself be a sanitary tissue product. It may be convolutedly wound about a core to form a roll. It may be combined with one or more other fibrous structures as a ply to form a multi-ply sanitary tissue product. In one example, a co-formed fibrous structure of the present invention may be convolutedly wound about a core to form a roll of co-formed sanitary tissue product. The rolls of sanitary tissue products may also be coreless.

In one example, the fibrous structures of the present invention exhibit a pore volume distribution such that greater than 8% and/or at least 10% and/or at least 14% and/or at least 18% and/or at least 20% and/or at least 22% and/or at least 25% and/or at least 29% and/or at least 34% and/or at least 40% and/or at least 50% of the total pore volume present in the fibrous structures exists in pores of radii of from 2.5 μm to 50 μm as measured by the Pore Volume Distribution Test Method described herein.

In yet another example, the fibrous structures of the present invention exhibit a pore volume distribution such that at least 2% and/or at least 9% and/or at least 10% and/or at least 12% and/or at least 17% and/or at least 18% and/or at least 28% and/or at least 32% and/or at least 43% of the total pore volume present in the fibrous structure exists in pores of radii of from 91 μm to 140 μm as measured by the Pore Volume Distribution Test Method described herein.

In even yet another example, the fibrous structures of the present invention exhibit a pore volume distribution such that at least 2% and/or at least 9% and/or at least 10% and/or at least 12% and/or at least 17% and/or at least 18% and/or at least 20% and/or at least 28% and/or at least 32% and/or at least 43% of the total pore volume present in the fibrous structure exists in pores of radii of from 91 μm to 120 μm and/or exhibit a pore volume distribution such that less than 50% and/or less than 45% and/or less than 40% and/or less than 38% and/or less than 35% and/or less than 30% of the total pore volume present in the fibrous structure exists in pores of radii of from 101 μm to 200 μm as measured by the Pore Volume Distribution Test Method described herein. In one example, the fibrous structures of the present invention exhibit a pore volume distribution such that at least 20% and/or at least 28% and/or at least 32% and/or at least 43% of the total pore volume present in the fibrous structure exists in pores of radii of from 91 μm to 120 μm and exhibit a pore volume distribution such that less than 40% and/or less than 38% and/or less than 35% and/or less than 30% of the total pore volume present in the fibrous structure exists in pores of radii of from 101 μm to 200 μm as measured by the Pore Volume Distribution Test Method described herein.

In even yet another example, the fibrous structures of the present invention exhibit a pore volume distribution such that at least 2% and/or at least 9% and/or at least 10% and/or at least 12% and/or at least 17% and/or at least 18% and/or at least 20% and/or at least 28% and/or at least 32% and/or at least 43% of the total pore volume present in the fibrous structure exists in pores of radii of from 91 μm to 140 μm and/or exhibit a pore volume distribution such that less than 50% and/or less than 45% and/or less than 40% and/or less than 38% and/or less than 35% and/or less than 30% of the total pore volume present in the fibrous structure exists in pores of radii of from 101 μm to 200 μm and/or exhibit a pore volume distribution such that less than 50% and/or less than 45% and/or less than 40% and/or less than 38% and/or less than 35% and/or less than 30% of the total pore volume present in the fibrous structure exists in pores of radii of from 121 μm to 200 μm as measured by the Pore Volume Distribution Test Method described herein. In another example, the fibrous structures of the present invention exhibit a pore volume distribution such that at least 43% of the total pore volume present in the fibrous structure exists in pores of radii of from 91 μm to 140 μm and exhibit a pore volume distribution less than 40% and/or less than 38% and/or less than 35% and/or less than 30% of the total pore volume present in the fibrous structure exists in pores of radii of from 101 μm to 200 μm and exhibit a pore volume distribution less than 40% and/or less than 38% and/or less than 35% and/or less than 30% of the total pore volume present in the fibrous structure exists in pores of radii of from 121 μm to 200 μm as measured by the Pore Volume Distribution Test Method described herein.

In even yet another example, the fibrous structures of the present invention exhibit a pore volume distribution such that at least 2% and/or at least 9% and/or at least 10% and/or at least 12% and/or at least 17% and/or at least 18% and/or at least 20% and/or at least 28% and/or at least 32% and/or at least 43% of the total pore volume present in the fibrous structure exists in pores of radii of from 91 μm to 140 μm and/or exhibit a pore volume distribution such that less than 50% and/or less than 45% and/or less than 40% and/or less than 38% and/or less than 35% and/or less than 30% of the total pore volume present in the fibrous structure exists in pores of radii of from 101 μm to 200 μm as measured by the Pore Volume Distribution Test Method described herein. In another example, the fibrous structures of the present invention exhibit a pore volume distribution such that at least 43% of the total pore volume present in the fibrous structure exists in pores of radii of from 91 μm to 140 μm and exhibit a pore volume distribution less than 40% and/or less than 38% and/or less than 35% and/or less than 30% of the total pore volume present in the fibrous structure exists in pores of radii of from 101 μm to 200 μm as measured by the Pore Volume Distribution Test Method described herein.

In one example, the fibrous structure of the present invention exhibits at least a bi-modal pore volume distribution (i.e., the pore volume distribution exhibits at least two modes). A fibrous structure according to the present invention exhibiting a bi-modal pore volume distribution provides beneficial absorbent capacity and absorbent rate as a result of the larger radii pores and beneficial surface drying as a result of the smaller radii pores.

Any of the components, for example the core component, of the scrubby fibrous structures of the present invention may be consolidated or unconsolidated, individually and/or together with other components.

### Process for Making a Fibrous Structure

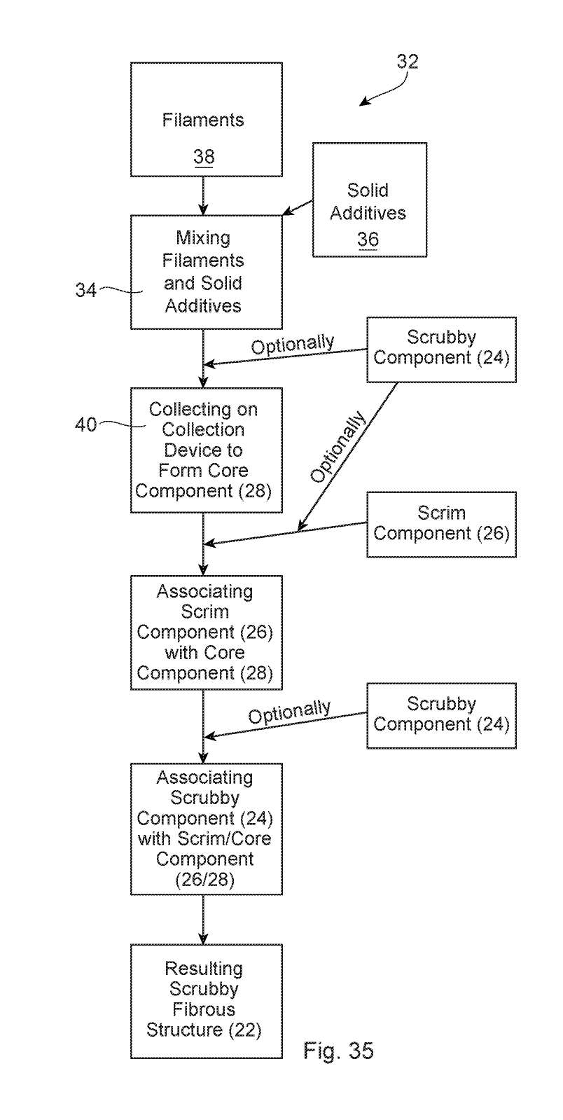

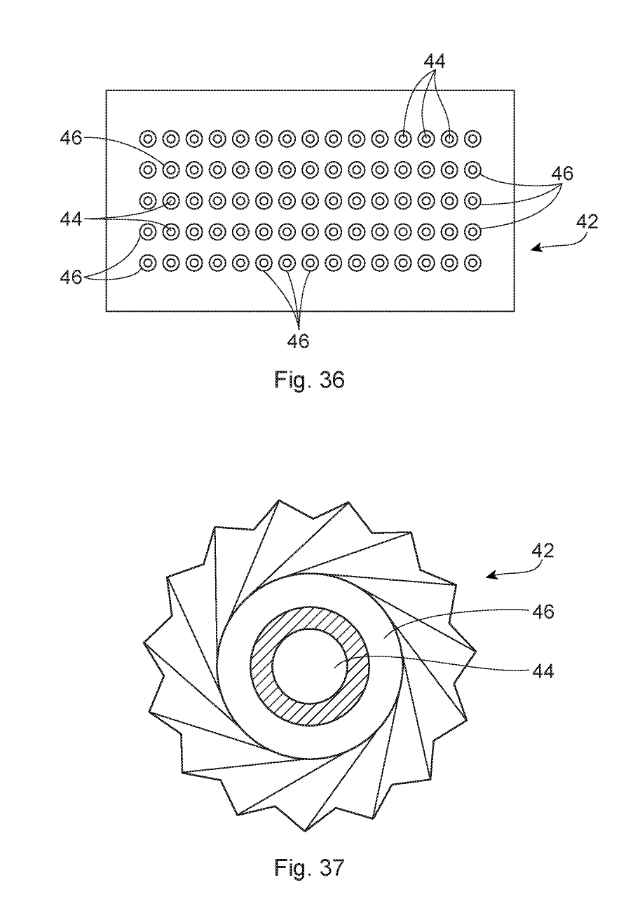

A non-limiting example of a process for making a fibrous structure according to the present invention is represented in FIG. 35. The process 32 shown in FIG. 35 comprises the steps of mixing 34 a plurality of solid additives 36 with a plurality of filaments 38 and collecting 40 the mixture on a collection device, for example a belt or fabric, such as a patterned belt, to form a core component 28. The collection device may be a patterned and/or molded belt that results in the fibrous structure exhibiting a surface pattern, such as a non-random, repeating pattern. The molded belt may have a three-dimensional pattern on it that gets imparted to the core component 28 during the process. In one example, the solid additives 36 are wood pulp fibers, such as SSK fibers and/or Eucalytpus fibers, and the filaments 38 are polypropylene filaments. The solid additives 36 may be combined with the filaments 38, such as by being delivered to a stream of filaments 38 from a hammermill via a solid additive spreader (such as a fiber spreader) and/or a forming head and/or eductor, to form a mixture of filaments 38 and solid additives 36. The filaments 38 may be created by meltblowing from a meltblow die, for example as shown in FIGS. 36 and 37.

In one example of the present invention, the core component 28 is made using a die 42, as shown in FIGS. 36 and 37, comprising at least one filament-forming hole 44, and/or 2 or more and/or 3 or more rows of filament-forming holes 44 from which filaments are spun. At least one row of holes contains 2 or more and/or 3 or more and/or 10 or more filament-forming holes 44. In addition to the filament-forming holes 44, the die 42 comprises fluid releasing holes 46, such as gas-releasing holes, in one example air-releasing holes, that provide attenuation to the filaments formed from the filament-forming holes 44. One or more fluid releasing holes 46 may be associated with a filament-forming hole 44 such that the fluid exiting the fluid-releasing hole 46 is parallel or substantially parallel (rather than angled like a knife-edge die) to an exterior surface of a filament 38 exiting the filament-forming hole 44. In one example, the fluid exiting the fluid-releasing hole 46 contacts the exterior surface of a filament 38 formed from a filament-forming hole 44 at an angle of less than 30° and/or less than 20° and/or less than 10° and/or less than 5° and/or about 0°. One or more fluid-releasing holes 46 may be arranged around a filament-forming hole 44. In one example, one or more fluid-releasing holes 46 are associated with a single filament-forming hole 44 such that the fluid exiting the one or more fluid-releasing holes 46 contacts the exterior surface of a single filament 38 formed from the single filament-forming hole 44. In one example, the fluid-releasing hole 46 permits a fluid, such as a gas, for example air, to contact the exterior surface of a filament 38 formed from a filament-forming hole 44 rather than contacting an inner surface of a filament 38, such as what happens when a hollow filament is formed.

In one example, the die 42 comprises a filament-forming hole 44 positioned within a fluid-releasing hole 46. The fluid-releasing hole 46 may be concentrically or substantially concentrically positioned around a filament-forming hole 44 such as is shown in FIGS. 36 and 37.

In another example, the die 42 comprises filament-forming holes 44 and fluid-releasing holes 46 arranged to produce a plurality of filaments 38 that exhibit a broader range of filament diameters than known filament-forming hole 44 dies, such as knife-edge dies.

In still another example, the die comprises a knife-edge die.

In one example, a scrubby component 24 may be incorporated into the core component 28 during forming of the core component 28 by combining one or more scrubby elements, such as scrubby fibrous elements, for example filaments and/or fibers, that exhibit an average diameter of greater than 5% and/or greater than 10% and/or greater than 15% and/or greater than 20% of the average diameter of the core component's filaments, with the core filaments that form the core component 28.

After forming the core component 28 on the collection device, a scrim component 26 may be formed on a surface of the core component 28 by depositing and/or associating a plurality of scrim fibrous elements that form the scrim component 26 with the core component's surface. In this example, another die, for example die 42, different from the die used to form the core filaments of the core component 28 may be used to form the scrim fibrous elements.

In another example, after the core component 28 has been formed on the collection device, a scrubby component 24 may be formed on a surface of the core component 28 by depositing and/or associating a plurality of scrubby fibrous elements that form the scrubby component 24 with the core component's surface. In this example, another die, for example die 42, different from the die used to form the core filaments of the core component 28 may be used to form the scrubby fibrous elements.

After forming the scrubby component 24 on a surface of the core component 28, a scrim component 26 may be formed on the scrubby component 24 or on another surface of the core component 28 by depositing and/or associating a plurality of scrim fibrous elements that form the scrim component 26 with a surface of the scrubby component 24 and/or the core component's surface. In this example, another die, for example die 42, different from the die used to form the core filaments of the core component 28 and the die used to form the scrubby fibrous elements of the scrubby component 24 may be used to form the scrim fibrous elements.

In another example, after the core component 28 has been formed on the collection device, a scrim component 26 may be formed on a surface of the core component 28 by depositing and/or associating a plurality of scrim fibrous elements that form the scrim component 26 with the core component's surface. In this example, another die, for example die 42, different from the die used to form the core filaments of the core component 28 may be used to form the scrim fibrous elements. In one example, a scrubby component 24 may be incorporated into the scrim component 26 during forming of the scrim component 26 by imparting a pattern, for example a surface pattern, such as a pattern that exhibits a scrubby quality, to a surface of the scrim component 26.

In yet another example, a scrubby component 24 may be incorporated into a scrim component 26 during forming of the scrim component 26 by imparting a pattern, for example a surface pattern, such as a pattern that exhibits a scrubby quality, to a surface of the scrim component 26 by combining one or more scrubby elements, such as scrubby fibrous elements, for example filaments and/or fibers, that exhibit an average diameter of greater than 5% and/or greater than 10% and/or greater than 15% and/or greater than 20% of the average diameter of the scrim component's fibrous elements, with the scrim fibrous elements that form the scrim component 26.

After forming the scrubby component 24 on a surface of the core component 28, a scrim component 26 may be formed on the scrubby component 24 or on another surface of the core component 28 by depositing and/or associating a plurality of scrim fibrous elements with a surface of the scrubby component 24 and/or the core component's surface. In this example, another die different from the die used to form the core filaments of the core component 28 and the die used to form the scrubby fibrous elements of the scrubby component 24 may be used to form the scrim fibrous elements.

The various components of the scrubby fibrous structures 22 of the present invention; namely, one or more core components 28, one or more scrim components 26, and one or more scrubby components 24 may be formed and/or arranged in any order within the scrubby fibrous structure, for example so long as the scrubby fibrous structure exhibits a scrubby quality according to the present invention. Further, each of the components, individually and/or together (in the form of a scrubby fibrous structure ply or multi-ply scrubby fibrous structure), may be subjected to post-processing operations such as embossing, thermal bonding, tuft-generating operations, moisture-imparting operations, and surface treating operations to form a finished fibrous structure. One example of a surface treating operation that the fibrous structure may be subjected to is the surface application of an elastomeric binder, such as ethylene vinyl acetate (EVA), latexes, and other elastomeric binders. Such an elastomeric binder may aid in reducing the lint created from the fibrous structure during use by consumers. The elastomeric binder may be applied to one or more surfaces of the fibrous structure in a pattern, especially a non-random repeating pattern, or in a manner that covers or substantially covers the entire surface(s) of the fibrous structure.

The process for making the scrubby fibrous structure of the present invention may be close coupled (where the fibrous structure is convolutedly wound into a roll prior to proceeding to a converting operation) or directly coupled (where the fibrous structure is not convolutedly wound into a roll prior to proceeding to a converting operation) with a converting operation to emboss, print, deform, surface treat, or other post-forming operation known to those in the art. For purposes of the present invention, direct coupling means that the scrubby fibrous structure can proceed directly into a converting operation rather than, for example, being convolutedly wound into a roll and then unwound to proceed through a converting operation.

The process of the present invention may include preparing individual rolls of fibrous structure and/or sanitary tissue product comprising such fibrous structure(s) that are suitable for consumer use. The fibrous structure may be contacted by a bonding agent (such as an adhesive and/or dry strength agent), such that the ends of a roll of sanitary tissue product according to the present invention comprise such adhesive and/or dry strength agent.

In one example, the scrubby fibrous structure and/or individual components are embossed and/or cut into sheets, and collected in stacks of scrubby fibrous structures.

The process of the present invention may include preparing individual rolls and/or sheets and/or stacks of sheets of scrubby fibrous structures that are suitable for consumer use.

In one example, one or more of the components of the scrubby fibrous structure may be made individually and then combined with one or more other components and/or other fibrous structures. In another example, two or more of the scrubby fibrous structures of the present invention may be combined with each other and/or with another fibrous structure to form a multi-ply scrubby fibrous structure.

The continuous polymer filament diameter distribution of all the components involved can be controlled by adjusting the attenuation process levers. These levers include, but are not limited to, the mass throughput ratio of attenuation fluid to polymer melt, the temperature of the attenuation fluid and polymer melt, spinning nozzle orifice size, polymer melt rheological properties, and polymer melt quenching. In one example, the polymer melt attenuation process can use a jet-to-melt mass ratio between 0 and 27. In another example, the polymer melt is extruded at 350F while the attenuation fluid was injected at 395° F. In two similar examples, polymer melt is either extruded through a 0.018″ orifice diameter or a 0.015″ orifice diameter at the same jet-to-melt mass ratio and temperature. In yet another example, different melt flow rate (MFR) combinations of isotactic polypropylene resins can be extruded. In still another example, cold air at 73° F. and four times more than the attenuation air by mass is injected into the forming zone and impinges the attenuation jet to drastically decrease polymer and air temperature.

Each fibrous structure can have either the same or different fiber diameter distribution as the other fibrous structures. In one example having a three-ply fibrous structure, the two plies sandwiching the center ply can have larger mean filament diameter with the same or different filament diameter distribution to provide more surface roughness. In a variation of the previous example, only one of the outer plies has a larger mean filament diameter with the same or different filament diameter distribution as the core ply, while the other outer ply has a smaller mean filament diameter with the same or different filament diameter distribution as the core ply. In another example involving a one-ply scrubby fibrous structure, the mean meltblown filament diameter is increased to provide scaffold structure for larger void space.

In one example of the present invention, the method for making a fibrous structure according to the present invention comprises the step of combining a plurality of filaments and optionally, a plurality of solid additives to form a fibrous structure that exhibits the properties of the fibrous structures of the present invention described herein. In one example, the filaments comprise thermoplastic filaments. In one example, the filaments comprise polypropylene filaments. In still another example, the filaments comprise natural polymer filaments. The method may further comprise subjecting the fibrous structure to one or more processing operations, such as calendaring the fibrous structure. In yet another example, the method further comprises the step of depositing the filaments onto a patterned belt that creates a non-random, repeating pattern of micro regions.

In still another example, two plies of scrubby fibrous structures of the present invention comprising a non-random, repeating pattern of microregions may be associated with one another such that protruding microregions, such as pillows, face inward into the two-ply fibrous structure formed.

The process for making fibrous structure 50 may be close coupled (where the fibrous structure is convolutedly wound into a roll prior to proceeding to a converting operation) or directly coupled (where the fibrous structure is not convolutedly wound into a roll prior to proceeding to a converting operation) with a converting operation to emboss, print, deform, surface treat, thermal bond, cut, stack or other post-forming operation known to those in the art. For purposes of the present invention, direct coupling means that the fibrous structure 50 can proceed directly into a converting operation rather than, for example, being convolutedly wound into a roll and then unwound to proceed through a converting operation.

### Non-Limiting Examples of Processes for Making Scrubby Fibrous Structure of the Present Invention

### Example 1

A 21.%:27.5%47.5%:4% blend of Lyondell-Basell PH835 polypropylene:Lyondell-Basell Metocene MF650W polypropylene:Lyondell-Basell Metocene MF650X:Ampacet 412951 opacifier is dry blended, to form a melt blend. The melt blend is heated to 475° F. through a melt extruder. A 15.5 inch wide Biax 12 row spinnerette with 192 nozzles per cross-direction inch, commercially available from Biax Fiberfilm Corporation, is utilized. 40 nozzles per cross-direction inch of the 192 nozzles have a 0.018 inch inside diameter while the remaining nozzles are solid, i.e. there is no opening in the nozzle. Approximately 0.19 grams per hole per minute (ghm) of the melt blend is extruded from the open nozzles to form meltblown filaments from the melt blend. Approximately 375 SCFM of compressed air, equivalent to a jet-to-melt mass ratio of 22, is heated such that the air exhibits a temperature of about 395° F. at the spinnerette. Approximately 475 g/minute of Golden Isle (from Georgia Pacific) 4825 semi-treated SSK pulp is defibrillated through a hammermill to form SSK wood pulp fibers (solid additive). Air at a temperature of about 85 to 90° F. and about 85% relative humidity (RH) is drawn into the hammermill. Approximately 1200 SCFM of air carries the pulp fibers to a solid additive spreader. The solid additive spreader turns the pulp fibers and distributes the pulp fibers in the cross-direction, for example by using one or more CD controllable eductors as described in U.S. Provisional Patent Application No. 62/094,087 filed Dec. 19, 2014, such that the pulp fibers are injected into the meltblown filaments at a non-90° angle (with respect to the flow of the meltblown filaments) through a 4 inch×15 inch cross-direction (CD) slot in a forming box as described in U.S. Provisional Patent Application No. 62/094,089 filed Dec. 19, 2014. The forming box surrounds the area where the meltblown filaments and pulp fibers are commingled. This forming box is designed to reduce the amount of air allowed to enter or escape from this commingling area; however, there is an additional 4 inch×15 inch spreader opposite the solid additive spreader designed to add cooling air. Approximately 1000 SCFM of air at approximately 80° F. is added through this additional spreader. A forming vacuum pulls air through a collection device, such as a patterned belt, thus collecting the commingled meltblown filaments and pulp fibers to form a fibrous structure comprising a pattern of non-random, repeating microregions. The fibrous structure formed by this process comprises about 75% by dry fibrous structure weight of pulp and about 25% by dry fibrous structure weight of meltblown filaments.

A meltblown layer of the meltblown filaments, such as a scrim, is added to both sides of the above formed fibrous structure. This addition of the meltblown layer can help reduce the lint created from the fibrous structure during use by consumers and is preferably performed prior to any thermal bonding operation of the fibrous structure. The two scrim layers can be the same or different than the meltblown filaments in the center formed fibrous structure. To make the meltblown filaments for the exterior layers, A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 420 SCFM of compressed air, equivalent to a jet-to-melt mass ratio of 22, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on top of the above formed fibrous structure.

An additional meltblown layer, such as a scrubbing scrim layer, is added to one side of the above layered fibrous structure. The basis weight and filament diameter of such meltblown layer is important in controlling its surface roughness. The meltblown filaments for this layer can be the same or different than the meltblown filaments used in other layers. To make the meltblown filaments for this scrubbing scrim layer, A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 88 SCFM of compressed air, equivalent to a jet-to-melt mass ratio of 4.6, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on top of the above formed fibrous structure. The fibrous structure may be convolutedly wound to form a roll of fibrous structure. The end edges of the roll of fibrous structure may be contacted with a material to create bond regions.

### Example 2

A 21.0%:27.5%47.5%:4% blend of Lyondell-Basell PH835 polypropylene:Lyondell-Basell Metocene MF650W polypropylene:Lyondell-Basell Metocene MF650X:Ampacet 412951 opacifier is dry blended, to form a melt blend. The melt blend is heated to about 405° F. through a melt extruder. A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 420 SCFM of compressed air, equivalent to a jet-to-melt mass ratio of 26, is heated such that the air exhibits a temperature of about 395° F. at the spinnerette. Approximately 1000 g/minute of Golden Isle (from Georgia Pacific) 4825 semi-treated SSK pulp is defibrillated through a hammermill to form SSK wood pulp fibers (solid additive). Air at a temperature of about 90° F. and about 75% relative humidity (RH) is drawn into the hammermill. Approximately 2000 SCFM of air carries the pulp fibers to two solid additive spreaders. The solid additive spreaders turns the pulp fibers and distributes the pulp fibers in the cross-direction, for example by using one or more CD controllable eductors as described in U.S. Provisional Patent Application No. 62/094,087 filed Dec. 19, 2014, such that the pulp fibers are injected into the meltblown filaments at a non-90° angle (with respect to the flow of the meltblown filaments) through a 4 inch×15 inch cross-direction (CD) slot in a forming box as described in U.S. Provisional Patent Application No. 62/094,089 filed Dec. 19, 2014. The forming box surrounds the area where the meltblown filaments and pulp fibers are commingled. This forming box is designed to reduce the amount of air allowed to enter or escape from this commingling area. The two slots are oriented opposite of one another on opposite sides of the meltblown filament spinnerette. A forming vacuum pulls air through a collection device, such as a non-patterned forming belt or through-air-drying fabric, thus collecting the commingled meltblown filaments and pulp fibers to form a fibrous structure. The fibrous structure formed by this process comprises about 80% by dry fibrous structure weight of pulp and about 20% by dry fibrous structure weight of meltblown filaments.

A meltblown layer of the meltblown filaments, such as a scrim, is added to both sides of the above formed fibrous structure. This addition of the meltblown layer can help reduce the lint created from the fibrous structure during use by consumers and is preferably performed prior to any thermal bonding operation of the fibrous structure. The basis weight and filament diameter of such meltblown layer is important in controlling its surface roughness. The meltblown filaments for the exterior layers are different than the meltblown filaments used on the opposite layer or in the center layer(s). To make the meltblown filaments for one of the exterior layers, A 15.5 inch wide Biax 12 row spinnerette with 192 nozzles per cross-direction inch, commercially available from Biax Fiberfilm Corporation, is utilized. 128 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 200 SCFM of compressed air, equivalent to a jet-to-melt mass ratio of 10.5, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on top of the above formed fibrous structure. To make the meltblown filaments for the opposite exterior layers, A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.015 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 420 SCFM of compressed air, equivalent to a jet-to-melt mass ratio of 22, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on the opposite side of the above formed composite fibrous structure.

The fibrous structure may be convolutedly wound to form a roll of fibrous structure. The end edges of the roll of fibrous structure may be contacted with a material to create bond regions.

### Example 3

A 21.%:27.5%47.5%:4% blend of Lyondell-Basell PH835 polypropylene:Lyondell-Basell Metocene MF650W polypropylene:Lyondell-Basell Metocene MF650X:Ampacet 412951 opacifier is dry blended, to form a melt blend. The melt blend is heated to 475° F. through a melt extruder. A 15.5 inch wide Biax 12 row spinnerette with 192 nozzles per cross-direction inch, commercially available from Biax Fiberfilm Corporation, is utilized. 40 nozzles per cross-direction inch of the 192 nozzles have a 0.018 inch inside diameter while the remaining nozzles are solid, i.e. there is no opening in the nozzle. Approximately 0.19 grams per hole per minute (ghm) of the melt blend is extruded from the open nozzles to form meltblown filaments from the melt blend. Approximately 375 SCFM of compressed air, equivalent to a jet-to-melt mass ratio of 22, is heated such that the air exhibits a temperature of about 395° F. at the spinnerette. Approximately 475 g/minute of Golden Isle (from Georgia Pacific) 4825 semi-treated SSK pulp is defibrillated through a hammermill to form SSK wood pulp fibers (solid additive). Air at a temperature of about 85 to 90° F. and about 85% relative humidity (RH) is drawn into the hammermill. Approximately 1200 SCFM of air carries the pulp fibers to a solid additive spreader. The solid additive spreader turns the pulp fibers and distributes the pulp fibers in the cross-direction, for example by using one or more CD controllable eductors as described in U.S. Provisional Patent Application No. 62/094,087 filed Dec. 19, 2014, such that the pulp fibers are injected into the meltblown filaments at a non-90° angle (with respect to the flow of the meltblown filaments) through a 4 inch×15 inch cross-direction (CD) slot in a forming box as described in U.S. Provisional Patent Application No. 62/094,089 filed Dec. 19, 2014. The forming box surrounds the area where the meltblown filaments and pulp fibers are commingled. This forming box is designed to reduce the amount of air allowed to enter or escape from this commingling area; however, there is an additional 4 inch×15 inch spreader opposite the solid additive spreader designed to add cooling air. Approximately 1000 SCFM of air at approximately 80° F. is added through this additional spreader. A forming vacuum pulls air through a collection device, such as a patterned belt, thus collecting the commingled meltblown filaments and pulp fibers to form a fibrous structure comprising a pattern of non-random, repeating microregions. The fibrous structure formed by this process comprises about 75% by dry fibrous structure weight of pulp and about 25% by dry fibrous structure weight of meltblown filaments.

A meltblown layer of the meltblown filaments, such as a scrim, is added to both sides of the above formed fibrous structure. This addition of the meltblown layer can help reduce the lint created from the fibrous structure during use by consumers and is preferably performed prior to any thermal bonding operation of the fibrous structure. The basis weight and filament diameter of such meltblown layer is important in controlling its surface roughness. The meltblown filaments for the exterior layers are the same as the meltblown filaments used on the opposite layer, but can be the same or different than the meltblown filaments used in the center layer(s). To make the meltblown filaments for the exterior layers, A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 420 SCFM of compressed air, equivalent to a jet-to-melt mass ratio of 22, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on top of the above formed fibrous structure. The fibrous structure may be convolutedly wound to form a roll of fibrous structure. The end edges of the roll of fibrous structure may be contacted with a material to create bond regions.

### Example 4

A 21.0%:27.5%47.5%:4% blend of Lyondell-Basell PH835 polypropylene:Lyondell-Basell Metocene MF650W polypropylene:Lyondell-Basell Metocene MF650X:Ampacet 412951 opacifier is dry blended, to form a melt blend. The melt blend is heated to about 405° F. through a melt extruder. A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 500 SCFM of compressed air, equivalent to a jet-to-melt mass ratio of 26, is heated such that the air exhibits a temperature of about 395° F. at the spinnerette. Approximately 1000 g/minute of Golden Isle (from Georgia Pacific) 4825 semi-treated SSK pulp is defibrillated through a hammermill to form SSK wood pulp fibers (solid additive). Air at a temperature of about 90° F. and about 75% relative humidity (RH) is drawn into the hammermill. Approximately 2000 SCFM of air carries the pulp fibers to two solid additive spreaders. The solid additive spreaders turns the pulp fibers and distributes the pulp fibers in the cross-direction, for example by using one or more CD controllable eductors as described in U.S. Provisional Patent Application No. 62/094,087 filed Dec. 19, 2014, such that the pulp fibers are injected into the meltblown filaments at a non-90° angle (with respect to the flow of the meltblown filaments) through a 4 inch×15 inch cross-direction (CD) slot in a forming box as described in U.S. Provisional Patent Application No. 62/094,089 filed Dec. 19, 2014. The forming box surrounds the area where the meltblown filaments and pulp fibers are commingled. This forming box is designed to reduce the amount of air allowed to enter or escape from this commingling area. The two slots are oriented opposite of one another on opposite sides of the meltblown filament spinnerette. A forming vacuum pulls air through a collection device, such as a non-patterned forming belt or through-air-drying fabric, thus collecting the commingled meltblown filaments and pulp fibers to form a fibrous structure. The fibrous structure formed by this process comprises about 80% by dry fibrous structure weight of pulp and about 20% by dry fibrous structure weight of meltblown filaments.

A meltblown layer of the meltblown filaments, such as a scrim, is added to both sides of the above formed fibrous structure. This addition of the meltblown layer can help reduce the lint created from the fibrous structure during use by consumers and is preferably performed prior to any thermal bonding operation of the fibrous structure. The basis weight and filament diameter of such meltblown layer is important in controlling its surface roughness. The meltblown filaments for the exterior layers are different than the meltblown filaments used on the opposite layer or in the center layer(s). To make the meltblown filaments for one of the exterior layers, A 15.5 inch wide Biax 12 row spinnerette with 192 nozzles per cross-direction inch, commercially available from Biax Fiberfilm Corporation, is utilized. 128 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 200 SCFM of compressed air, equivalent to a jet-to-melt mass ratio of 10.5, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on top of the above formed fibrous structure. To make the meltblown filaments for the opposite exterior layers, A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 420 SCFM of compressed air, equivalent to a jet-to-melt mass ratio of 22, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on the opposite side of the above formed composite fibrous structure.

The fibrous structure may be convolutedly wound to form a roll of fibrous structure. The end edges of the roll of fibrous structure may be contacted with a material to create bond regions.

### Example 5

A 21.%:27.5%47.5%:4% blend of Lyondell-Basell PH835 polypropylene:Lyondell-Basell Metocene MF650W polypropylene:Lyondell-Basell Metocene MF650X:Ampacet 412951 opacifier is dry blended, to form a melt blend. The melt blend is heated to 475° F. through a melt extruder. A 15.5 inch wide Biax 12 row spinnerette with 192 nozzles per cross-direction inch, commercially available from Biax Fiberfilm Corporation, is utilized. 40 nozzles per cross-direction inch of the 192 nozzles have a 0.018 inch inside diameter while the remaining nozzles are solid, i.e. there is no opening in the nozzle. Approximately 0.19 grams per hole per minute (ghm) of the melt blend is extruded from the open nozzles to form meltblown filaments from the melt blend. Approximately 375 SCFM of compressed air, equivalent to a jet-to-melt mass ratio of 22, is heated such that the air exhibits a temperature of about 395° F. at the spinnerette. Approximately 475 g/minute of Golden Isle (from Georgia Pacific) 4825 semi-treated SSK pulp is defibrillated through a hammermill to form SSK wood pulp fibers (solid additive). Air at a temperature of about 85 to 90° F. and about 85% relative humidity (RH) is drawn into the hammermill. Approximately 1200 SCFM of air carries the pulp fibers to a solid additive spreader. The solid additive spreader turns the pulp fibers and distributes the pulp fibers in the cross-direction such that the pulp fibers are injected into the meltblown filaments in a perpendicular fashion (with respect to the flow of the meltblown filaments) through a 4 inch×15 inch cross-direction (CD) slot. A forming box surrounds the area where the meltblown filaments and pulp fibers are commingled. This forming box is designed to reduce the amount of air allowed to enter or escape from this commingling area; however, there is an additional 4 inch×15 inch spreader opposite the solid additive spreader designed to add cooling air. Approximately 1000 SCFM of air at approximately 80° F. is added through this additional spreader. A forming vacuum pulls air through a collection device, such as a patterned belt, thus collecting the commingled meltblown filaments and pulp fibers to form a fibrous structure comprising a pattern of non-random, repeating microregions. The fibrous structure formed by this process comprises about 75% by dry fibrous structure weight of pulp and about 25% by dry fibrous structure weight of meltblown filaments.

A meltblown layer of the meltblown filaments, such as a scrim, is added to both sides of the above formed fibrous structure. This addition of the meltblown layer can help reduce the lint created from the fibrous structure during use by consumers and is preferably performed prior to any thermal bonding operation of the fibrous structure. The two scrim layers can be the same or different than the meltblown filaments in the center formed fibrous structure. To make the meltblown filaments for the exterior layers, A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 420 SCFM of compressed air, equivalent to a jet-to-melt mass ratio of 22, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on top of the above formed fibrous structure.

An additional meltblown layer, such as a scrubbing scrim layer, is added to one side of the above layered fibrous structure. The basis weight and filament diameter of such meltblown layer is important in controlling its surface roughness. The meltblown filaments for this layer can be the same or different than the meltblown filaments used in other layers. To make the meltblown filaments for this scrubbing scrim layer, A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 88 SCFM of compressed air, equivalent to a jet-to-melt mass ratio of 4.6, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on top of the above formed fibrous structure. The fibrous structure may be convolutedly wound to form a roll of fibrous structure. The end edges of the roll of fibrous structure may be contacted with a material to create bond regions.

### Example 6

A 21.0%:27.5%47.5%:4% blend of Lyondell-Basell PH835 polypropylene:Lyondell-Basell Metocene MF650W polypropylene:Lyondell-Basell Metocene MF650X:Ampacet 412951 opacifier is dry blended, to form a melt blend. The melt blend is heated to about 405° F. through a melt extruder. A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 420 SCFM of compressed air, equivalent to a jet-to-melt mass ratio of 26, is heated such that the air exhibits a temperature of about 395° F. at the spinnerette. Approximately 1000 g/minute of Golden Isle (from Georgia Pacific) 4825 semi-treated SSK pulp is defibrillated through a hammermill to form SSK wood pulp fibers (solid additive). Air at a temperature of about 90° F. and about 75% relative humidity (RH) is drawn into the hammermill. Approximately 2000 SCFM of air carries the pulp fibers to two solid additive spreaders. The solid additive spreaders turns the pulp fibers and distributes the pulp fibers in the cross-direction such that the pulp fibers are injected into the meltblown filaments in a perpendicular fashion (with respect to the flow of the filaments) through two 4 inch×15 inch cross-direction (CD) slots. A forming box surrounds the area where the meltblown filaments and pulp fibers are commingled. This forming box is designed to reduce the amount of air allowed to enter or escape from this commingling area. The two slots are oriented opposite of one another on opposite sides of the meltblown filament spinnerette. A forming vacuum pulls air through a collection device, such as a non-patterned forming belt or through-air-drying fabric, thus collecting the commingled meltblown filaments and pulp fibers to form a fibrous structure. The fibrous structure formed by this process comprises about 80% by dry fibrous structure weight of pulp and about 20% by dry fibrous structure weight of meltblown filaments.

A meltblown layer of the meltblown filaments, such as a scrim, is added to both sides of the above formed fibrous structure. This addition of the meltblown layer can help reduce the lint created from the fibrous structure during use by consumers and is preferably performed prior to any thermal bonding operation of the fibrous structure. The basis weight and filament diameter of such meltblown layer is important in controlling its surface roughness. The meltblown filaments for the exterior layers are different than the meltblown filaments used on the opposite layer or in the center layer(s). To make the meltblown filaments for one of the exterior layers, A 15.5 inch wide Biax 12 row spinnerette with 192 nozzles per cross-direction inch, commercially available from Biax Fiberfilm Corporation, is utilized. 128 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 200 SCFM of compressed air, equivalent to a jet-to-melt mass ratio of 10.5, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on top of the above formed fibrous structure. To make the meltblown filaments for the opposite exterior layers, A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.015 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 420 SCFM of compressed air, equivalent to a jet-to-melt mass ratio of 22, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on the opposite side of the above formed composite fibrous structure.

The fibrous structure may be convolutedly wound to form a roll of fibrous structure. The end edges of the roll of fibrous structure may be contacted with a material to create bond regions.

### Example 7

A 21.%:27.5%47.5%:4% blend of Lyondell-Basell PH835 polypropylene:Lyondell-Basell Metocene MF650W polypropylene:Lyondell-Basell Metocene MF650X:Ampacet 412951 opacifier is dry blended, to form a melt blend. The melt blend is heated to 475° F. through a melt extruder. A 15.5 inch wide Biax 12 row spinnerette with 192 nozzles per cross-direction inch, commercially available from Biax Fiberfilm Corporation, is utilized. 40 nozzles per cross-direction inch of the 192 nozzles have a 0.018 inch inside diameter while the remaining nozzles are solid, i.e. there is no opening in the nozzle. Approximately 0.19 grams per hole per minute (ghm) of the melt blend is extruded from the open nozzles to form meltblown filaments from the melt blend. Approximately 375 SCFM of compressed air, equivalent to a jet-to-melt mass ratio of 22, is heated such that the air exhibits a temperature of about 395° F. at the spinnerette. Approximately 475 g/minute of Golden Isle (from Georgia Pacific) 4825 semi-treated SSK pulp is defibrillated through a hammermill to form SSK wood pulp fibers (solid additive). Air at a temperature of about 85 to 90° F. and about 85% relative humidity (RH) is drawn into the hammermill. Approximately 1200 SCFM of air carries the pulp fibers to a solid additive spreader. The solid additive spreader turns the pulp fibers and distributes the pulp fibers in the cross-direction such that the pulp fibers are injected into the meltblown filaments in a perpendicular fashion (with respect to the flow of the meltblown filaments) through a 4 inch×15 inch cross-direction (CD) slot. A forming box surrounds the area where the meltblown filaments and pulp fibers are commingled. This forming box is designed to reduce the amount of air allowed to enter or escape from this commingling area; however, there is an additional 4 inch×15 inch spreader opposite the solid additive spreader designed to add cooling air. Approximately 1000 SCFM of air at approximately 80° F. is added through this additional spreader. A forming vacuum pulls air through a collection device, such as a patterned belt, thus collecting the commingled meltblown filaments and pulp fibers to form a fibrous structure comprising a pattern of non-random, repeating microregions. The fibrous structure formed by this process comprises about 75% by dry fibrous structure weight of pulp and about 25% by dry fibrous structure weight of meltblown filaments.

A meltblown layer of the meltblown filaments, such as a scrim, is added to both sides of the above formed fibrous structure. This addition of the meltblown layer can help reduce the lint created from the fibrous structure during use by consumers and is preferably performed prior to any thermal bonding operation of the fibrous structure. The basis weight and filament diameter of such meltblown layer is important in controlling its surface roughness. The meltblown filaments for the exterior layers are the same as the meltblown filaments used on the opposite layer, but can be the same or different than the meltblown filaments used in the center layer(s). To make the meltblown filaments for the exterior layers, A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 420 SCFM of compressed air, equivalent to a jet-to-melt mass ratio of 22, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on top of the above formed fibrous structure. The fibrous structure may be convolutedly wound to form a roll of fibrous structure. The end edges of the roll of fibrous structure may be contacted with a material to create bond regions.

### Example 8

A 21.0%:27.5%47.5%:4% blend of Lyondell-Basell PH835 polypropylene:Lyondell-Basell Metocene MF650W polypropylene:Lyondell-Basell Metocene MF650X:Ampacet 412951 opacifier is dry blended, to form a melt blend. The melt blend is heated to about 405° F. through a melt extruder. A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 500 SCFM of compressed air, equivalent to a jet-to-melt mass ratio of 26, is heated such that the air exhibits a temperature of about 395° F. at the spinnerette. Approximately 1000 g/minute of Golden Isle (from Georgia Pacific) 4825 semi-treated SSK pulp is defibrillated through a hammermill to form SSK wood pulp fibers (solid additive). Air at a temperature of about 90° F. and about 75% relative humidity (RH) is drawn into the hammermill. Approximately 2000 SCFM of air carries the pulp fibers to two solid additive spreaders. The solid additive spreaders turns the pulp fibers and distributes the pulp fibers in the cross-direction such that the pulp fibers are injected into the meltblown filaments in a perpendicular fashion (with respect to the flow of the filaments) through two 4 inch×15 inch cross-direction (CD) slots. A forming box surrounds the area where the meltblown filaments and pulp fibers are commingled. This forming box is designed to reduce the amount of air allowed to enter or escape from this commingling area. The two slots are oriented opposite of one another on opposite sides of the meltblown filament spinnerette. A forming vacuum pulls air through a collection device, such as a non-patterned forming belt or through-air-drying fabric, thus collecting the commingled meltblown filaments and pulp fibers to form a fibrous structure. The fibrous structure formed by this process comprises about 80% by dry fibrous structure weight of pulp and about 20% by dry fibrous structure weight of meltblown filaments.

A meltblown layer of the meltblown filaments, such as a scrim, is added to both sides of the above formed fibrous structure. This addition of the meltblown layer can help reduce the lint created from the fibrous structure during use by consumers and is preferably performed prior to any thermal bonding operation of the fibrous structure. The basis weight and filament diameter of such meltblown layer is important in controlling its surface roughness. The meltblown filaments for the exterior layers are different than the meltblown filaments used on the opposite layer or in the center layer(s). To make the meltblown filaments for one of the exterior layers, A 15.5 inch wide Biax 12 row spinnerette with 192 nozzles per cross-direction inch, commercially available from Biax Fiberfilm Corporation, is utilized. 128 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 200 SCFM of compressed air, equivalent to a jet-to-melt mass ratio of 10.5, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on top of the above formed fibrous structure. To make the meltblown filaments for the opposite exterior layers, A 15.5 inch wide Biax 12 row spinnerette with 192 nozzles per cross-direction inch, commercially available from Biax Fiberfilm Corporation, is utilized. 64 nozzles per cross-direction inch of the 192 nozzles have a 0.018 inch inside diameter while the remaining nozzles are solid, i.e. there is no opening in the nozzle. Approximately 0.21 grams per hole per minute (ghm) of the melt blend is extruded from the open nozzles to form meltblown filaments from the melt blend. Approximately 420 SCFM of compressed air, equivalent to a jet-to-melt mass ratio of 22, is heated such that the air exhibits a temperature of about 395° F. at the spinnerette. A forming vacuum pulls air through a collection device, such as a non-patterned forming belt or through-air-drying fabric, thus collecting the meltblown filaments to form a fibrous structure on the opposite side of the above formed composite fibrous structure.

The fibrous structure may be convolutedly wound to form a roll of fibrous structure. The end edges of the roll of fibrous structure may be contacted with a material to create bond regions.

### Test Methods

Unless otherwise specified, all tests described herein including those described under the Definitions section and the following test methods are conducted on samples that have been conditioned in a conditioned room at a temperature of 23° C.±1.0° C. and a relative humidity of 50%±2% for a minimum of 12 hours prior to the test. All plastic and paper board packaging articles of manufacture, if any, must be carefully removed from the samples prior to testing. The samples tested are “usable units.” “Usable units” as used herein means sheets, flats from roll stock, pre-converted flats, and/or single or multi-ply products. Except where noted all tests are conducted in such conditioned room, all tests are conducted under the same environmental conditions and in such conditioned room. Discard any damaged product. Do not test samples that have defects such as wrinkles, tears, holes, and like. All instruments are calibrated according to manufacturer's specifications. Samples conditioned as described herein are considered dry samples (such as “dry fibrous structures”) for purposes of this invention.

### Basis Weight Test Method

Basis weight of a fibrous structure sample is measured by selecting twelve (12) individual fibrous structure samples and making two stacks of six individual samples each. If the individual samples are connected to one another vie perforation lines, the perforation lines must be aligned on the same side when stacking the individual samples. A precision cutter is used to cut each stack into exactly 3.5 in.×3.5 in. squares. The two stacks of cut squares are combined to make a basis weight pad of twelve squares thick. The basis weight pad is then weighed on a top loading balance with a minimum resolution of 0.01 g. The top loading balance must be protected from air drafts and other disturbances using a draft shield. Weights are recorded when the readings on the top loading balance become constant. The Basis Weight is calculated as follows:

$$\begin{matrix}Basis Weight \\ ( lbs \text{/} 3000 {ft}^{2} )\end{matrix} = \frac{Weight of basis weight pad ( g ) \times 3000 {ft}^{2}}{\begin{matrix}453.6 g \text{/} lbs \times 12 samples \times \\ [ 12.25 {in}^{2} ( Area of basis weight pad ) \text{/} 144 {in}^{2} ]\end{matrix}}$$

$$\begin{matrix}Basis Weight \\ ( g \text{/} {m}^{2} )\end{matrix} = \frac{Weight of basis weight pad ( g ) \times 10 , 000 {cm}^{2} \text{/} {m}^{2}}{79.0321 {cm}^{2} ( Area of basis weight pad ) \times 12 samples}$$

MD Basis Weight Coefficient of Variation (“MD Basis Weight Variation” or “MD Basis Weight COV”) is defined as the standard deviation of basis weights divided by the average of basis weights as measured according to the Basis Weight Test Method described herein for 30 50 mm (MD)×100 mm (CD) fibrous structure samples as measured according to the Basis Weight Test Method described herein.

The level of filaments present in a fibrous structure having an initial basis weight can be determined by measuring the filament basis weight of a fibrous structure by using the Basis Weight Test Method after separating all non-filament materials from a fibrous structure. Different approaches may be used to achieve this separation. For example, non-filament material may be dissolved in an appropriate dissolution agent, such as sulfuric acid or Cadoxen, leaving the filaments intact with their mass essentially unchanged. The filaments are then weighed. The weight percentage of filaments present in the fibrous structure is then determined by the equation:

% wt. Filaments=100*(Filament Mass/Initial Basis Weight of Fibrous Structure)

The % wt. Solid Additives present in the fibrous structure can then be determined by subtracting the % wt. Filaments from 100% to arrive at the % wt. Solid Additives.

### Pore Volume Distribution Test Method

Pore Volume Distribution measurements are made on a TRI/Autoporosimeter (TRI/Princeton Inc. of Princeton, N.J.). The TRI/Autoporosimeter is an automated computer-controlled instrument for measuring pore volume distributions in porous materials (e.g., the volumes of different size pores within the range from 1 to 1000 μm effective pore radii). Complimentary Automated Instrument Software, Release 2000.1, and Data Treatment Software, Release 2000.1 is used to capture, analyze and output the data. More information on the TRI/Autoporosimeter, its operation and data treatments can be found in The Journal of Colloid and Interface Science 162 (1994), pgs 163-170, incorporated here by reference.

As used in this application, determining Pore Volume Distribution involves recording the increment of liquid that enters a porous material as the surrounding air pressure changes. A sample in the test chamber is exposed to precisely controlled changes in air pressure. The size (radius) of the largest pore able to hold liquid is a function of the air pressure. As the air pressure increases (decreases), different size pore groups drain (absorb) liquid. The pore volume of each group is equal to this amount of liquid, as measured by the instrument at the corresponding pressure. The effective radius of a pore is related to the pressure differential by the following relationship.

Pressure differential=[(2)γ cos Θ]/effective radius

where γ=liquid surface tension, and Θ=contact angle.

Typically pores are thought of in terms such as voids, holes or conduits in a porous material. It is important to note that this method uses the above equation to calculate effective pore radii based on the constants and equipment controlled pressures. The above equation assumes uniform cylindrical pores. Usually, the pores in natural and manufactured porous materials are not perfectly cylindrical, nor all uniform. Therefore, the effective radii reported here may not equate exactly to measurements of void dimensions obtained by other methods such as microscopy. However, these measurements do provide an accepted means to characterize relative differences in void structure between materials.

The equipment operates by changing the test chamber air pressure in user-specified increments, either by decreasing pressure (increasing pore size) to absorb liquid, or increasing pressure (decreasing pore size) to drain liquid. The liquid volume absorbed at each pressure increment is the cumulative volume for the group of all pores between the preceding pressure setting and the current setting.

In this application of the TRI/Autoporosimeter, the liquid is a 0.2 weight % solution of octylphenoxy polyethoxy ethanol (Triton X-100 from Union Carbide Chemical and Plastics Co. of Danbury, Conn.) in distilled water. The instrument calculation constants are as follows: ρ (density)=1 g/cm³; γ (surface tension)=31 dynes/cm; cos Θ=1. A 1.2 μm Millipore Glass Filter (Millipore Corporation of Bedford, Mass.; Catalog # GSWP09025) is employed on the test chamber's porous plate. A plexiglass plate weighing about 24 g (supplied with the instrument) is placed on the sample to ensure the sample rests flat on the Millipore Filter. No additional weight is placed on the sample.

The remaining user specified inputs are described below. The sequence of pore sizes (pressures) for this application is as follows (effective pore radius in μm): 1, 2.5, 5, 10, 15, 20, 30, 40, 50, 60, 70, 80, 90, 100, 120, 140, 160, 180, 200, 225, 250, 275, 300, 350, 400, 500, 600, 800, 1000. This sequence starts with the sample dry, saturates it as the pore settings increase (typically referred to with respect to the procedure and instrument as the 1^{st} absorption).

In addition to the test materials, a blank condition (no sample between plexiglass plate and Millipore Filter) is run to account for any surface and/or edge effects within the chamber. Any pore volume measured for this blank run is subtracted from the applicable pore grouping of the test sample. This data treatment can be accomplished manually or with the available TRI/Autoporosimeter Data Treatment Software, Release 2000.1.

Percent (%) Total Pore Volume is a percentage calculated by taking the volume of fluid in the specific pore radii range divided by the Total Pore Volume. The TRI/Autoporosimeter outputs the volume of fluid within a range of pore radii. The first data obtained is for the “2.5 micron” pore radii which includes fluid absorbed between the pore sizes of 1 to 2.5 micron radius. The next data obtained is for “5 micron” pore radii, which includes fluid absorbed between the 2.5 micron and 5 micron radii, and so on. Following this logic, to obtain the volume held within the range of 91-140 micron radii, one would sum the volumes obtained in the range titled “100 micron”, “110 micron”, “120 micron”, “130 micron”, and finally the “140 micron” pore radii ranges. For example, % Total Pore Volume 91-140 micron pore radii=(volume of fluid between 91-140 micron pore radii)/Total Pore Volume.

### Diameter Test Method

The diameter of a fibrous element, for example fiber or filament, discrete or within a scrubby fibrous structure is determined by using a Scanning Electron Microscope (SEM) or an Optical Microscope and an image analysis software. A magnification of 200 to 10,000 times is chosen such that the fibrous elements are suitably enlarged for measurement. When using the SEM, the samples are sputtered with gold or a palladium compound to avoid electric charging and vibrations of the fibrous element in the electron beam. A manual procedure for determining the fibrous element diameters is used from the image (on monitor screen) taken with the SEM or the optical microscope. Using a mouse and a cursor tool, the edge of a randomly selected fibrous element is sought and then measured across its width (i.e., perpendicular to fibrous element direction at that point) to the other edge of the fibrous element. A scaled and calibrated image analysis tool provides the scaling to get actual reading in μm. For fibrous elements within a fibrous structure, several fibrous element are randomly selected across the sample of the fibrous structure using the SEM or the optical microscope. At least two portions of the fibrous structure are cut and tested in this manner. Altogether at least 100 such measurements are made and then all data are recorded for statistical analysis. The recorded data are used to calculate average (mean) of the fibrous element diameters, standard deviation of the fibrous element diameters, and median of the fibrous element diameters.

Another useful statistic is the calculation of the amount of the population of fibrous elements that is below a certain upper limit. To determine this statistic, the software is programmed to count how many results of the fibrous element diameters are below an upper limit and that count (divided by total number of data and multiplied by 100%) is reported in percent as percent below the upper limit, such as percent below 1 micrometer diameter or %-submicron, for example. We denote the measured diameter (in μm) of an individual circular fibrous element as di.

In the case that the fibrous elements have non-circular cross-sections, the measurement of the fibrous element diameter is determined as and set equal to the hydraulic diameter which is four times the cross-sectional area of the fibrous element divided by the perimeter of the cross-section of the fibrous element (outer perimeter in case of hollow fibrous elements). The number-average diameter, alternatively average diameter is calculated as:

$${d}_{num} = \frac{{\sum }_{i = 1}^{n} {d}_{i}}{n}$$

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fibrous structure comprising:
a. one or more core components;
b. one or more scrim components; and
c. one or more scrubby components;
wherein the components are different from one another.

2. The fibrous structure according to claim 1 wherein at least one of the core components comprises a plurality of solid additives.

3. The fibrous structure according to claim 1 wherein at least one of the core components comprises a plurality of core fibrous elements.

4. The fibrous structure according to claim 3 wherein at least one of the core components comprises a plurality of solid additives and a plurality of the core fibrous elements.

5. The fibrous structure according to claim 3 wherein at least one of the core fibrous elements comprises a polymer.

6. The fibrous structure according to claim 5 wherein the polymer is a thermoplastic polymer.

7. The fibrous structure according to claim 6 wherein at least one of the core fibrous elements exhibits an average fiber diameter of less than 50 μm.

8. The fibrous structure according to claim 1 wherein at least one of the core components comprises one or more scrubby components.

9. The fibrous structure according to claim 8 wherein at least one of the scrubby components comprises a scrubby element.

10. The fibrous structure according to claim 9 wherein the scrubby element comprises a scrubby fibrous element.

11. The fibrous structure according to claim 10 wherein the scrubby fibrous element exhibits an average fiber diameter of less than 250 μm.

12. The fibrous structure according to claim 1 wherein at least one of the scrim components is adjacent to at least one of the core components.

13. The fibrous structure according to claim 12 wherein at least one of the core components is positioned between two scrim components.

14. The fibrous structure according to claim 1 wherein at least one of the scrim components comprises a plurality of scrim fibrous elements.

15. The fibrous structure according to claim 14 wherein at least one of the scrim fibrous elements exhibits an average fiber diameter of less than 50 μm.

16. The fibrous structure according to claim 1 wherein at least one of the scrim components comprises one or more scrubby components.

17. The fibrous structure according to claim 16 wherein at least one of the scrubby components comprises a scrubby element.

18. The fibrous structure according to claim 17 wherein the scrubby element comprises a scrubby fibrous element.

19. The fibrous structure according to claim 18 wherein the scrubby fibrous element exhibits an average fiber diameter of less than 250 μm.

20. The fibrous structure according to claim 17 wherein the scrubby element comprises a textured pattern present on a surface of the scrim component.

21. The fibrous structure according to claim 1 wherein at least one of the scrubby components comprises a plurality of scrubby fibrous elements.

22. The fibrous structure according to claim 21 wherein at least one of the scrubby fibrous elements exhibits an average fiber diameter of less than 250 μm.

23. The fibrous structure according to claim 21 wherein the scrubby component comprises a textured pattern of the scrubby fibrous elements

24. The fibrous structure according to claim 21 wherein the scrubby fibrous elements are present on a surface of one or more of the scrim components.
